(19) United States
(12) Patent Application Publication
(10) Pub. No.: US 2015/0310461 A1
(43) Pub. Date: Oct. 29, 2015

(54) OPERATING METHOD AND APPARATUS OF SMART SYSTEM FOR POWER CONSUMPTION OPTIMIZATION

(71) Applicant: SAMSUNG ELECTRONICS CO., LTD., Suwon-si (KR)

(72) Inventors: Dong-Seop LEE, Suwon-si (KR); Sung-Mok SEO, Suwon-si (KR); Hye-Jung CHO, Anyang-si (KR)

(73) Assignee: SAMSUNG ELECTRONICS CO., LTD., Suwon-si (KR)

(21) Appl. No.: 14/695,774

(22) Filed: Apr. 24, 2015

(30) Foreign Application Priority Data
Apr. 25, 2014 (KR) 10-2014-0050053

(51) Int. Cl. G06Q 30/02; H04L 12/28; H04L 29/08

(52) U.S. Cl. CPC G06Q 30/0202; H04L 67/12; H04L 12/2827; G06Q 50/06

(57) ABSTRACT

The present disclosure relates to a sensor network, Machine Type Communication (MTC), Machine-to-Machine (M2M) communication, and technology for Internet of Things (IoT). The present disclosure may be applied to intelligent services based on the above technologies, such as smart home, smart building, smart city, smart car, connected car, health care, digital education, smart retail, security and safety services. A method for operating a server in a smart system and a server are provided. The method may include: determining an electricity rate system for an electronic device based on at least one of rate information according to power use of the electronic device and power usage information of the electronic device; and transmitting information of the electricity rate system to a user device.

### CROSS-REFERENCE TO RELATED APPLICATION

This application claims priority from Korean Application No. 10-2014-0050053, which was filed in the Korean Intellectual Property Office on Apr. 25, 2014, the entire content of which is hereby incorporated by reference.

### BACKGROUND

1. Field

Apparatuses and methods consistent with exemplary embodiments relate to optimizing power consumption of devices in a smart system.

2. Description of the Related Art

The Internet has evolved from a human-centered connection network where human beings generate and consume information to an Internet of Things (IoT) network that exchanges and processes information between distributed components, such as things. An Internet of Everything (IoE) technology where big data processing technology is combined with the IoT technology through a connection to a cloud server has also emerged. In order to implement the IoT, technology components such as sensing technologies, wireless/wired communication and network interfaces, service interface technology, and security technology may be required. Recently, sensor networks, Machine to Machine (M2M), and Machine-Type Communication (MTC), etc., for connecting things have been studied.

In the IoT environment, an intelligent Internet Technology (IT) service which creates new value in human beings' lives may be provided by collecting and analyzing data generated in connected things. The IoT may be applied to areas such as smart homes, smart buildings, smart city, smart cars or connected cars, smart grid, healthcare, smart appliances, and an advanced healthcare service through fusion and combining conventional Information Technology (IT) technologies and various industries.

In the IoT environment as described above, power consumption of a smart system needs to be optimized.

### SUMMARY

One or more exemplary embodiments provide a method and an apparatus for determining and recommending an optimal electricity rate system by collecting and analyzing various bits of data in a smart system in an IoT environment.

Further, one or more exemplary embodiments provide a method and an apparatus for recommending a maximum output prediction and a contract power on the basis of climate patterns and/or power use patterns through a contract optimization service in a smart system of an IoT environment.

Further still, one or more exemplary embodiments provide a method and an apparatus for recommending a low cost c electricity rate system on the basis of climate information, real-time power use information and future event based power prediction module in a smart system of an IoT environment.

Further still, one or more exemplary embodiments provide a method and an apparatus for optimizing power consumption by controlling a power consumption device on the basis of modeling through data learning in a smart system of an IoT environment.

According to an aspect of an exemplary embodiment, there is provided a method for operating a server in a smart system, the method including: determining an electricity rate system for an electronic device based on at least one of rate information of the electronic device and power usage information of the electronic device; and transmitting information about the electricity rate system to a user device.

The determining the electricity rate system may further include determining at least one of a Tier-based rate system, a Time Of Use-based rate system, a Critical Peak Pricing-based rate system, a Real-Time Pricing-based rate system, a promotion rate system, and a penalty rate system, based on at least one of the rate information and the power usage information, wherein the rate information may include at least one of a rate receipt for each time period among a plurality of time periods of the electronic device and rate transfer information, and the power usage information may include power consumption data for each time period among the plurality of time periods of the electronic device.

The determining the electricity rate system may further include: collecting climate information; and determining the electricity rate system for the electronic device using at least one of the rate information, the power usage information, and the climate information.

The determining the electricity rate system may further include determining the electricity rate system that minimizes power consumption costs of the electronic device based on at least one of past use information according to the rate information, the power usage information, electricity rate system information according to an area, and climate information.

The determining the electricity rate system may further include: predicting a future power use rate based on at least one of a past rate, a present rate, climate information according to a time zone, and energy information according to a time zone; and determining the electricity rate system of the electronic device according to the predicted future power use rate.

The climate information may include at least one of temperature information, humidity information, and sunshine amount information, wherein a weight may be applied to each of the temperature information, the humidity information, and the sunshine amount information, and wherein the weight applied to each of the temperature information, the humidity information, and the sunshine amount information may be determined based on at least one of whether an ambient temperature is in a normal range of ambient temperatures and whether a climate forecast is in a normal range of climate forecasts.

The determining the electricity rate system may further include: collecting at least one of energy storage system information and renewable energy information; and determining the electricity rate system for the electronic device according to at least one of the rate information and the power usage information, and according to at least one of the energy storage system information and the renewable energy information.

The determining the electricity rate system may further include: determining renewable energy based on at least one of an ambient temperature, a wind speed, and an amount of sunshine; and determining the electricity rate system based on at least one of the determined renewable energy, a power rate, a prediction of the amount of power consumed for one day, a life cycle of the energy storage system, and a charging rate of the energy storage system.

The method may further include determining a power consumption pattern for minimizing power consumption of the electronic device based on the determined electricity rate system; determining device control information corresponding to the power consumption pattern; and transmitting at least one of the determined power consumption pattern and the device control information to at least one of the user device and the electronic device.

The power consumption pattern may be determined based on at least one of an electricity rate system variable, a contract power variable, and a consumption pattern variable, and the power consumption pattern may include at least one of an electricity rate system optimization value, a real-time contract power optimization value, and a real-time consumption pattern optimization value.

According to an aspect of another exemplary embodiment, there is provided a server device of a smart system, the server device including: a processor configured to determine an electricity rate system corresponding to an electronic device based on at least one of rate information according to past use of the electronic device and power usage information of the electronic device; and a transceiver configured to transmit information about the electricity rate system to a user device.

The processor may be further configured to determine that the electricity rate system includes at least one of a Tier-based rate system, a Time Of Use-based rate system, a Critical Peak Pricing-based rate system, a Real-Time Pricing-based rate system, a promotion rate system, and a penalty rate system, based on at least one of the rate information and the power usage information, wherein the rate information may include at least one of a rate receipt for each time period among a plurality of time periods of the electronic device and rate transfer information, and the power usage information may include power consumption data for each time period among the plurality of time periods of the electronic device.

The processor may be further configured to collect climate information and determine the electricity rate system for the electronic device according to at least one of the rate information, the power usage information, and the climate information.

The processor may be further configured to determine the electricity rate system that minimizes power consumption costs of the electronic device on the basis of at least one of the past use information according to the rate information, the power usage information, electricity rate system information according to an area, and climate information.

The processor may be further configured to predict a future power use rate on the basis of at least one of a past rate, a present rate, climate information according to a time zone, and energy information according to a time zone, and determine the electricity rate system of the electronic device according to the predicted future power use rate.

The climate information may include at least one of temperature information, humidity information, and sunshine amount information, wherein a weight is applied to each of the temperature information, the humidity information, and the sunshine amount information, and wherein the weight applied to each of the temperature information, the humidity information, and the sunshine amount information is determined on the basis of at least one of whether an ambient temperature is in a normal range of ambient temperatures and whether a climate forecast is in a normal range of climate forecasts.

The processor may be further configured to collect at least one of energy storage system information and renewable energy information, and determine the electricity rate system for the electronic device according to at least one of the rate information and the power usage information, and according to at least one of the energy storage system information and the renewable energy information.

The processor may be further configured to determine renewable energy based on at least one of an ambient temperature, a wind speed, and the amount of sunshine, and determine the electricity rate system based on at least one of the determined renewable energy, a power rate, a prediction of the amount of consumed power for one day, a life cycle of the energy storage system, and a charging rate of the energy storage system.

The processor may be further configured to determine a power consumption pattern for minimizing power consumption of the electronic device on the basis of the determined electricity rate system, determine device control information corresponding to the power consumption pattern, and transmit at least one of the determined power consumption pattern and the determined device control information to at least one of the user device and the electronic device.

The processor may be further configured to determine the power consumption pattern on the basis of at least one of an electricity rate system variable, a contract power variable, and a consumption pattern variable, and wherein the power consumption pattern may include at least one of an electricity rate system optimization value, a contract power optimization value, and a consumption pattern optimization value.

According to an aspect of another exemplary embodiment, there is provided a method of optimizing a smart system, the method including: collecting rate information of an electronic device and power usage information of the electronic device over a predetermined time period; predicting an amount of power consumption of the electronic device on the basis of the collected rate information and the collected power usage information over a future time period; and determining an optimal rate system by minimizing the amount of power consumption of the electronic device over the future time period based on the predicted amount of power consumption.

The determining the optimal rate system may further include comparing the rate information and the power usage in a regression model.

The regression model may include at least one of polynomial regression, Artificial Neural Network, and Support Vector Regression.

### BRIEF DESCRIPTION OF THE DRAWINGS

The above and/or other aspects will be more apparent from the following detailed description of exemplary embodiments taken in conjunction with the accompanying drawings, in which:

FIG. 1 is a diagram illustrating an operation of a smart system for optimization of power consumption according to an exemplary embodiment;

FIG. 2 is a diagram illustrating an example of a process for determining an optimal electricity rate system according to rate information of a consumer according to an exemplary embodiment;

FIGS. 3A to 3D are diagrams illustrating a simulation result according to a determination of an exemplary electricity rate system shown in FIG. 2;

FIG. 4 is a diagram illustrating an example of a process for determining an optimal electricity rate system according to rate information of a consumer according to an exemplary embodiment;

FIGS. 5A to SE are diagrams illustrating a simulation result according to a determination of an exemplary electricity rate system shown in FIG. 4;

FIG. 6 is a diagram illustrating an example of a process of determining a renewable energy based exemplary optimal electricity rate system;

FIGS. 7A to 7F are diagrams illustrating a simulation result according to a determination of an exemplary electricity rate system shown in FIG. 6;

FIG. 8 is a diagram illustrating a modeling method for optimization of power consumption according to an exemplary embodiment;

FIG. 9 is a flowchart of an exemplary embodiment illustrating a climate response power prediction regression model;

FIGS. 10A and 10B are diagrams illustrating an example of a real-time rate prediction regression model;

FIG. 11 is a diagram illustrating an example of an optimal model;

FIG. 12 is a flowchart illustrating an exemplary embodiment of an operation method of a smart system for optimization of power consumption according to an exemplary embodiment; and

FIG. 13 is a block diagram illustrating an exemplary embodiment of an operation device of a smart system for optimization of power consumption according to an exemplary embodiment.

### DETAILED DESCRIPTION

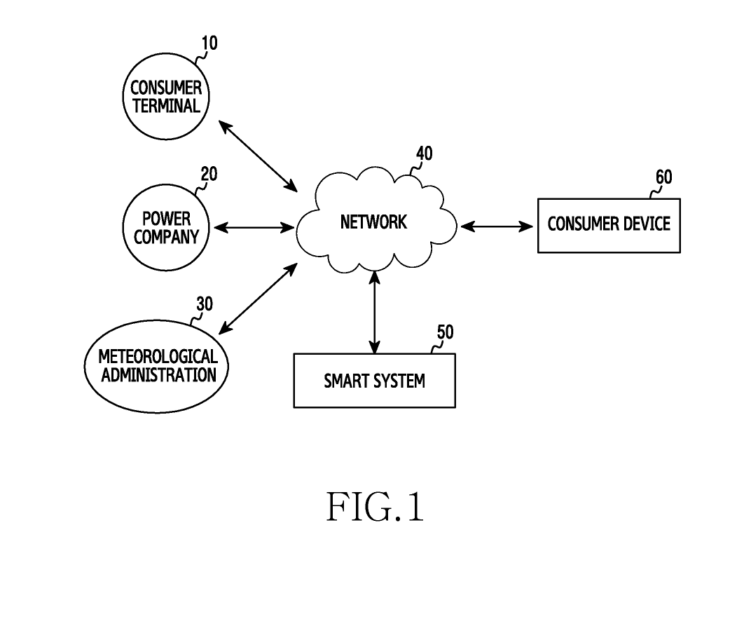

Exemplary embodiments will now be described in detailed with reference to FIGS. 1-13. However, the exemplary embodiments should not be interpreted as limiting the scope of an inventive concept. A person skilled in the art will understand that the principles of the present disclosure can be implemented in a variety of ways, and may be implemented in any wired or wireless communication system having a proper arrangement. Expressions such as “at least one of,” when preceding a list of elements, modify the entire list of elements and do not modify the individual elements of the list.

One or more exemplary embodiments provide an electricity rate system recommendation and an electricity rate system-based device automatic control method for power consumption optimization and pattern modeling, future event-based power usage prediction on the basis of climate, and power use history.

According to an exemplary embodiment, a rate system may basically be divided into a fixed rate system and a flexible rate system. The fixed rate system may be called a flat rate system. For example, in a fixed rate system, a power usage rate is not changed by a usage and/or a use time and is free from a price fluctuation risk according to climate, market, and economic conditions. A Tier-based rate system is an example of the fixed rate system. A Tier-based rate system may divide accumulated power usage into multiple steps to determine different rates with respect to a unit power in each step.

In a flexible rate system, a power use rate may be changed by various elements such as use time and/or usage. A flexible rate system according to an exemplary embodiment may be divided into a Time of Use (TOU)-based rate system, a Critical Peak Pricing (CPP)-based rate system, and a Real-Time Pricing (RTP)-based rate system. The TOU-based rate system may refer to a flexible rate system where a rate for a unit power is variable in each period. For example, in the TOU-based rate system, a weekend rate may be different from a weekday rate or a daytime rate may be different from a nighttime rate. The CPP-based rate system may refer to a flexible rate system where a rate for a unit power is variable on the basis of accumulated power usage. For example, in a CPP-based rate system, the amount of a peak power for accumulated power usage exists, and a rate for each unit power in a section where the accumulated power usage is less than or equal to the amount of the peak power may be different from a rate for each unit power in a section where the accumulated power usage is greater than or equal to the amount of the peak power. The RTP-based rate system may refer to a rate system where a rate for a unit power is published in real time. For example, in an RTP-based rate system, a rate for a unit power may be published for each specific period (e.g., every hour, every day, or every week) on the basis of fuel price fluctuations, operations, or power demand and supply situations.

The fixed rate system and the flexible rate system may be divided according to whether a rate for a unit power is variable on the basis of a specific time section. For example, a rate system where a rate for a unit power is not changed for 24 hours corresponding to one day may be referred to as a fixed rate system and a rate system where a rate for a unit power is changed for 24 hours may be referred to as a flexible rate system. In the fixed rate system and the flexible rate system, the rate for the unit power may be changed by an external factor (e.g., oil price fluctuations).

Additionally, a rate system may be a rate system in which two or more rate systems among the electricity rate systems as described above are combined. Furthermore, a rate system may be a rate system in which a rate system (e.g., various rate systems such as promotion rate system and/or penalty rate system) designed by each operator is combined. For example, the promotion rate system may be a rate system which discounts a rate for each unit power in a specific time period. The penalty rate system may be a rate system which adds an additional rate to a rate for each unit power when power usage is larger than or equal to a threshold amount in a specific time period. In addition, the penalty rate system may be a rate system which discounts a rate for each unit power or adds an additional rate to a rate for each unit power when the amount of the power use in a specific period is less than or equal to or is larger than or equal to a threshold amount selected by a consumer.

FIG. 1 is a diagram for describing an operation of a smart system for optimization of power consumption according to an exemplary embodiment. As shown in FIG. 1, a consumer terminal 10 provides power rate information of home/buildings/plants, use rate system information, consumer device usage information, Energy Storage System (ESS) information, and renewable energy information, to a smart system 50 through a network 40. Further, a power company 20 provides past power usage, power peak information, and contract power information for each consumer to the smart system 50 through the network 40. In addition, a meteorological administration 30 provides past climate information and prediction climate information to the smart system 50 through the network 40. The smart system 50 may collect various pieces of information from the consumer terminal 10, the power company 20, the meteorological administration 30, predict the amount of power consumption on the basis of the collected information, and recommend the amount of the contract power to the consumer terminal 10 on the basis of the amount of the predicted power consumption. Further, the smart system 50 may determine an optimal rate system according to the amount of the predicted power consumption and provide the determined optimal rate system to the consumer terminal 10. Further, the smart system 50 may determine power consumption optimal patterns on the basis of the determined optimal rate system to provide the determined power consumption optimal patterns to the consumer terminal 10. In addition, the smart system 50 provides a device control service which controls an operation of a network-based consumer device 60 on the basis of the power consumption optimal patterns. Herein, the consumer device 60 may include, for example, a TV, a gateway, a mobile terminal, a network interworking appliance, or the like. According to an exemplary embodiment, the smart system 50 may be at least one of the consumer terminal 10 and a server for optimizing power consumption of the consumer device 60.

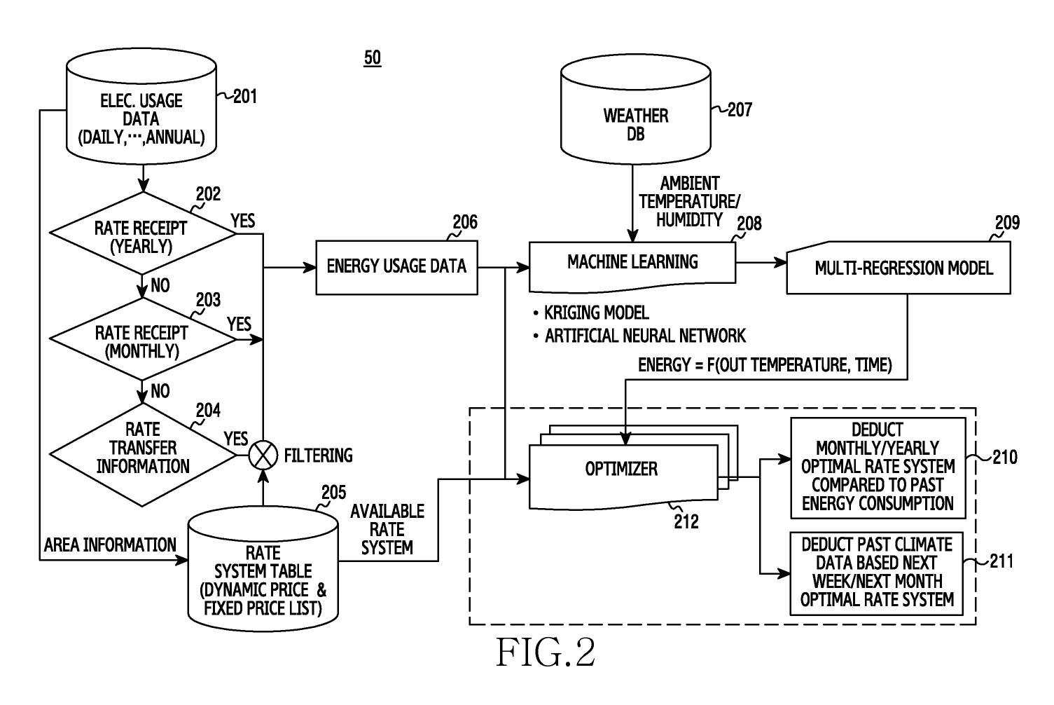

FIG. 2 is a diagram illustrating an example of a process for determining an optimal rate system according to rate information of a consumer. As shown in FIG. 2, a smart system according to an exemplary embodiment may detect energy usage data (201) using yearly rate receipts (202), monthly rate receipts (203), rate transfer information (204), and rate system table (205) information as rate information, and may include an Optimizer 212 in order to deduct monthly/yearly optimal rate system compared to past energy consumption (210) through a regression model (209) using the detected energy usage data (206). The smart system may include a weather database DB (207) input to a machine learning step 208, which may be a Kriging model or an artificial neural network. Further, the smart system may deduct next week/next month optimal rate system (211) by additionally using climate information (e.g., external device temperature information or humidity information) including past meteorological data as described below. The weather DB comprises the climate information. In an exemplary embodiment, a rate system table may be selected or configured on the basis of a consumer's area information. For example, the rate system table may include a rate system policy of an operator according to a consumer's area. Herein, the rate system policy may include detailed rate system policy for a flexible rate system and a fixed rate system. According to an exemplary embodiment, a smart system 50 may determine one rate system among rate systems classified with the fixed rate system by a rate system determination scheme as shown in FIG. 2 as an optimal rate system. In addition, according to an exemplary embodiment, the smart system 50 may determine an optimal rate system by additionally considering a promotion rate system and/or a penalty rate system. For example, an optimal rate system determined in the smart system 50 may be a fixed rate system to which at least one of the promotion rate system and/or the penalty rate system is applied.

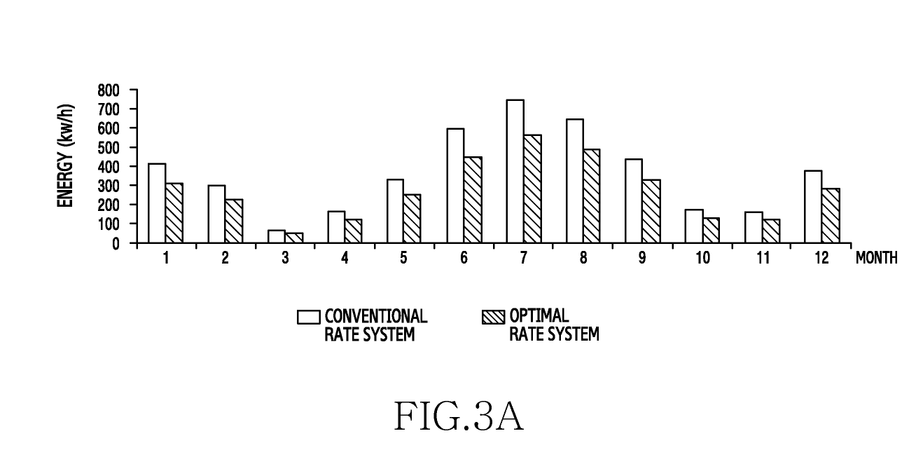

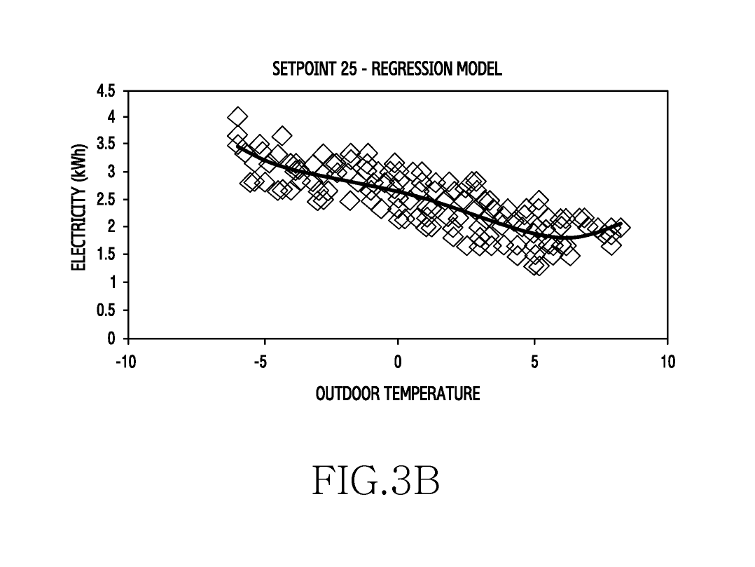

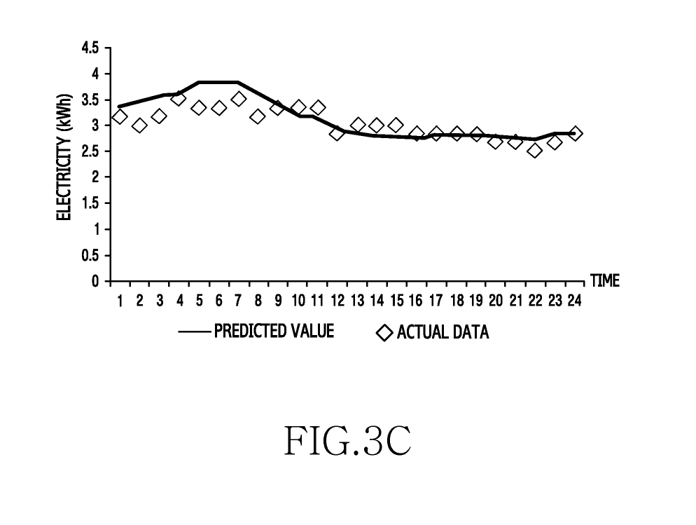

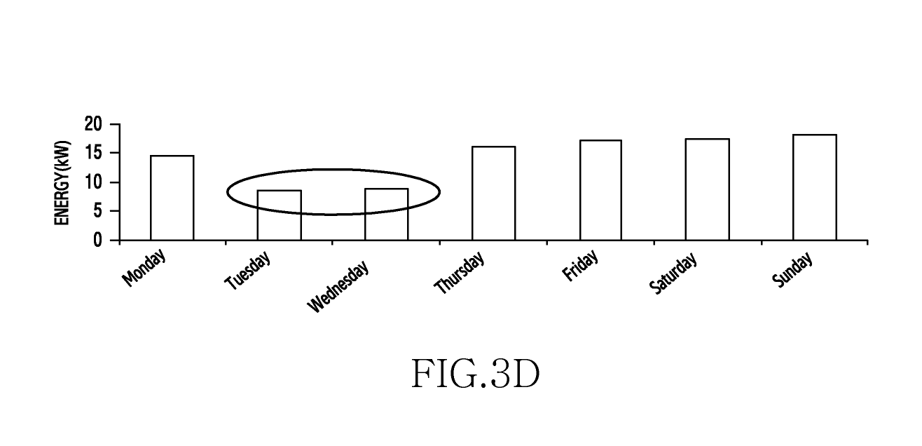

FIGS. 3A to 3D are diagrams illustrating a simulation result according to a determination of a fixed rate system as shown in FIG. 2. In particular, FIG. 3A illustrates a result of comparing the amount of yearly energy consumption according to monthly/yearly optimal rate system determination compared to past energy consumption. For example, FIG. 3A is a result of comparing and analyzing a difference between the amount of energy consumption of an existing rate system and the amount of energy consumption of an optimal rate system determined according to an exemplary embodiment for each month (for one year).

FIGS. 3B to 3D are comparison results according to a next week/next month optimal rate system determination on the basis of past meteorological data. An optimal rate system is determined by mathematical model deduction and energy consumption prediction by connecting energy consumption data and meteorological data for the past one year. FIG. 3B is a diagram illustrating a regression model with setpoint 25, for analyzing and modeling meteorological data and energy consumption patterns and illustrates consumption patterns for the amount of a power according to an ambient, e.g., outdoor, temperature. FIG. 3C is a diagram for modeling verification and illustrates that predicted data has an error of less than 5% when compared with actual data. FIG. 3D is a diagram for the next week energy prediction and rate analysis for each day through modeling. FIG. 3D illustrates that the amount of energy predicted to be used on Tuesday and Wednesday is smaller than any other day of the week. Therefore, a rate system may be determined and an energy consumption device may be controlled s to distribute and use a power on Tuesday and Wednesday in which the amount of predicted energy use is minimized.

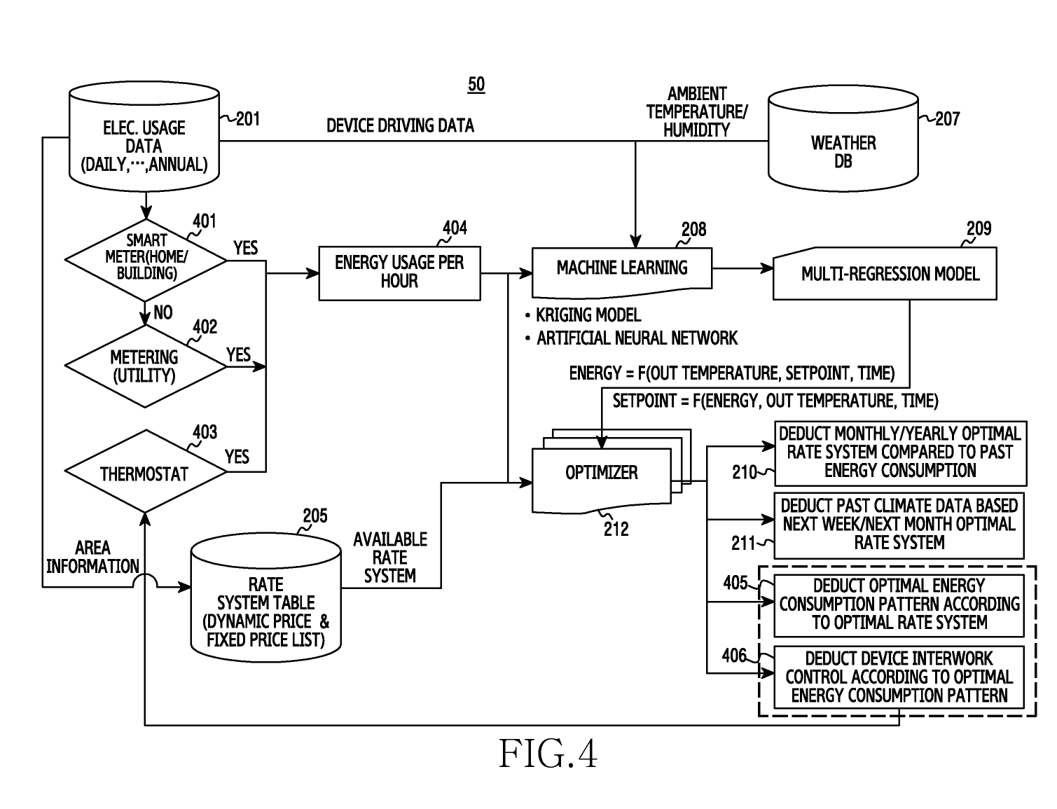

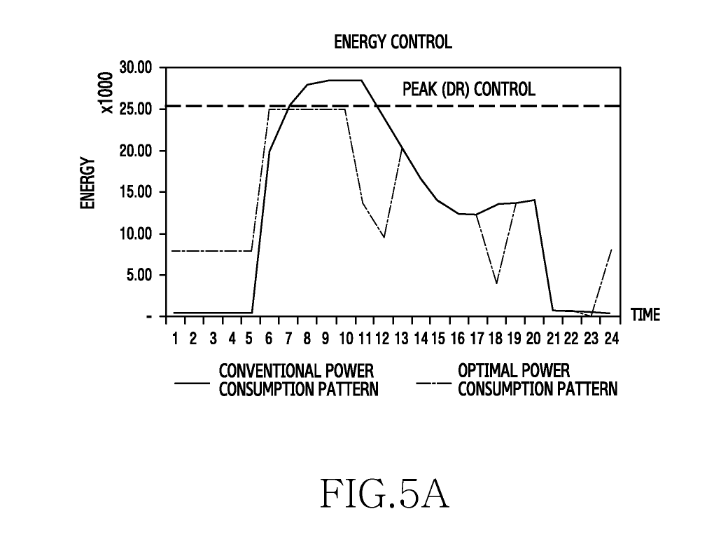

FIG. 4 is a diagram illustrating an example of a process for determining an optimal rate system according to rate information of a consumer. As shown in FIG. 4, a smart system 50 according to an exemplary embodiment may detect energy usage data per hour (404) using information on real-time power usage, rate system table (205) information or external temperature information as rate information. The smart system 50 may include an optimizer 212 in order to deduct a monthly/yearly optimal rate system compared to past energy consumption (210) on the basis of a regression model (209) using the detected energy usage data. The smart system may include a weather database (207) input to a machine learning process (208), which may be a Kriging model or an artificial neural network. Further, the smart system 50 may deduct next week/next month optimal rate system according to past climate information (211) additionally using climate information. In addition, information on the real-time power usage may include energy usage (201), which is consumed by a smart meter (401), metering (402), or thermostat (403), per hour. The rate system table may be selected or configured on the basis of a consumer's area information. For example, the rate system table (205) may include a rate system policy of an operator according to a consumer's area. Herein, the rate system policy may include detailed rate system policy for a flexible rate system and a fixed rate system. Further, the smart system 50 may determine optimal energy consumption patterns corresponding to an optimal rate system (405) and deduct interworking control information for controlling an operation of a device on the basis of the optimal energy consumption patterns (406). Herein, the device may refer to all devices which consume energy. According to an exemplary embodiment, the smart system 50 may determine at least one rate system of the fixed rate system and/or the flexible rate system by a rate system determination scheme as shown in FIG. 4 as an optimal rate system. In addition, according an exemplary embodiment, the smart system 50 may determine an optimal rate system by additionally considering a promotion rate system and/or a penalty rate system. For example, an optimal rate system determined in the smart system 50 may be a fixed rate system to which at least one of the promotion rate system and/or the penalty rate system is applied, or a flexible rate system to which at least one of the promotion rate system and/or the penalty rate system is applied.

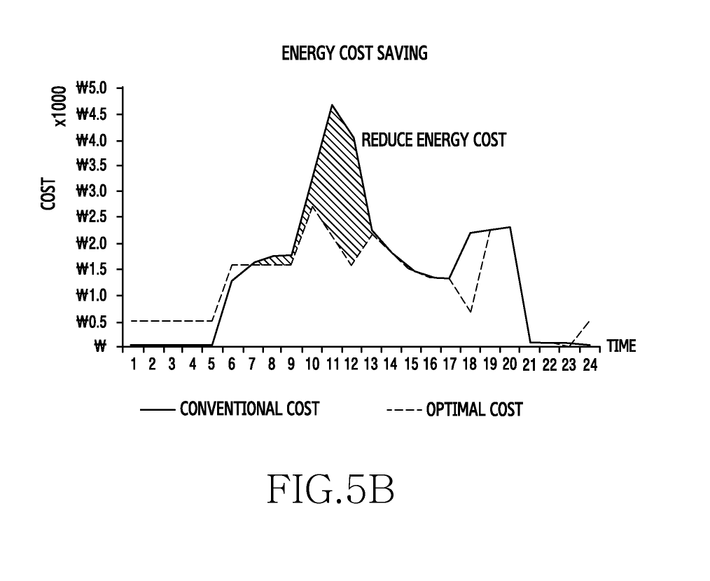

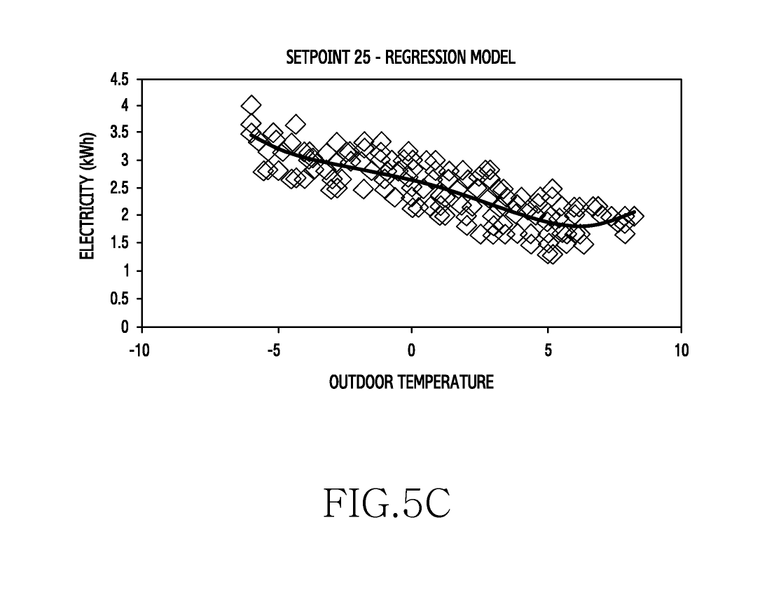

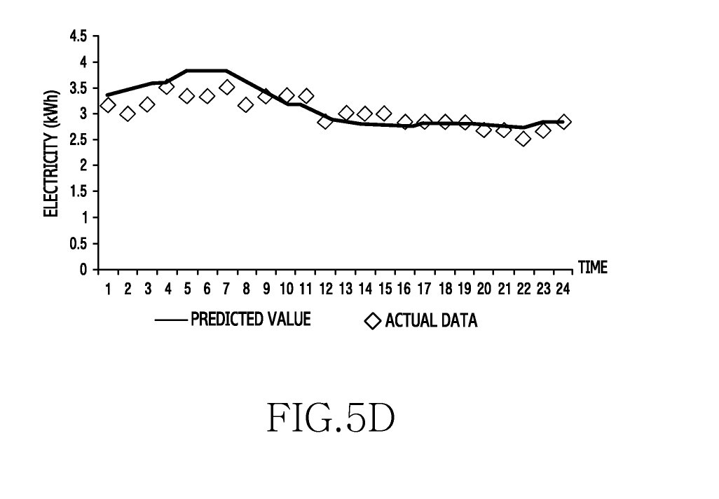

FIGS. 5A to 5E are diagrams illustrating a simulation result according to a determination of a fixed or flexible rate system as shown in FIG. 4. FIG. 5A is a diagram illustrating an example of optimal power consumption patterns according to a determined optimal rate system. For example, an optimal power consumption pattern according to the determined optimal rate system is determined to reduce a peak power (or a Demand Response (DR)), compared to an existing power consumption pattern. FIG. 5B illustrates a power consumption cost per hour of an optimal power consumption pattern according to an exemplary embodiment, compared to an existing power consumption pattern. As shown in FIG. 5B, when a device is controlled according to an optimal power consumption pattern, it is possible to identify that an energy cost is reduced by a shaded part, in comparison with a case in which a device operates according to a conventional power consumption pattern.

FIGS. 5C to 5E illustrate a device interworking control according to an optimal power consumption pattern and are diagrams illustrating an example of an energy mathematical model which connects energy consumption data and meteorological data in the past year or predetermined period, and a device control scheduling based setpoint calculation result. FIG. 5C is a diagram illustrating a regression model with setpoint 25, for analyzing and modeling climate data and energy consumption patterns, and FIG. 5D is a diagram illustrating a modeling verification, and illustrates that predicted data has an error of less than 5% when compared with actual data. FIG. 5E is a diagram illustrating a modeling based device operation control, and illustrates that a power of a part of the diagram indicated by a slash can be reduced through a temperature control of a device for each time period. For example, as shown in FIG. 5E, when the temperature of the device is controlled according to an optimal power consumption pattern, it is possible to identify that an energy cost is reduced by a shaded part, when compared to the case in which a device operates with a previously configured temperature.

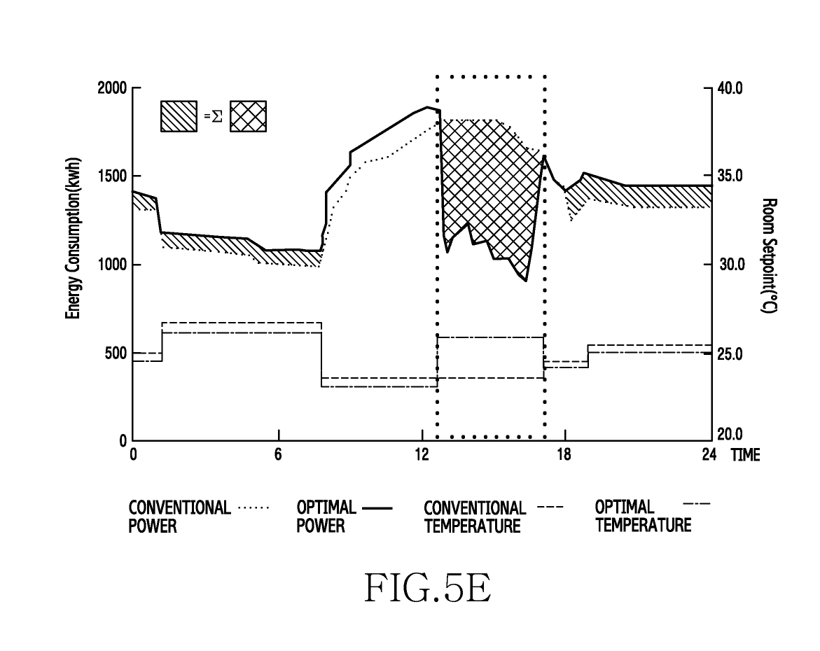

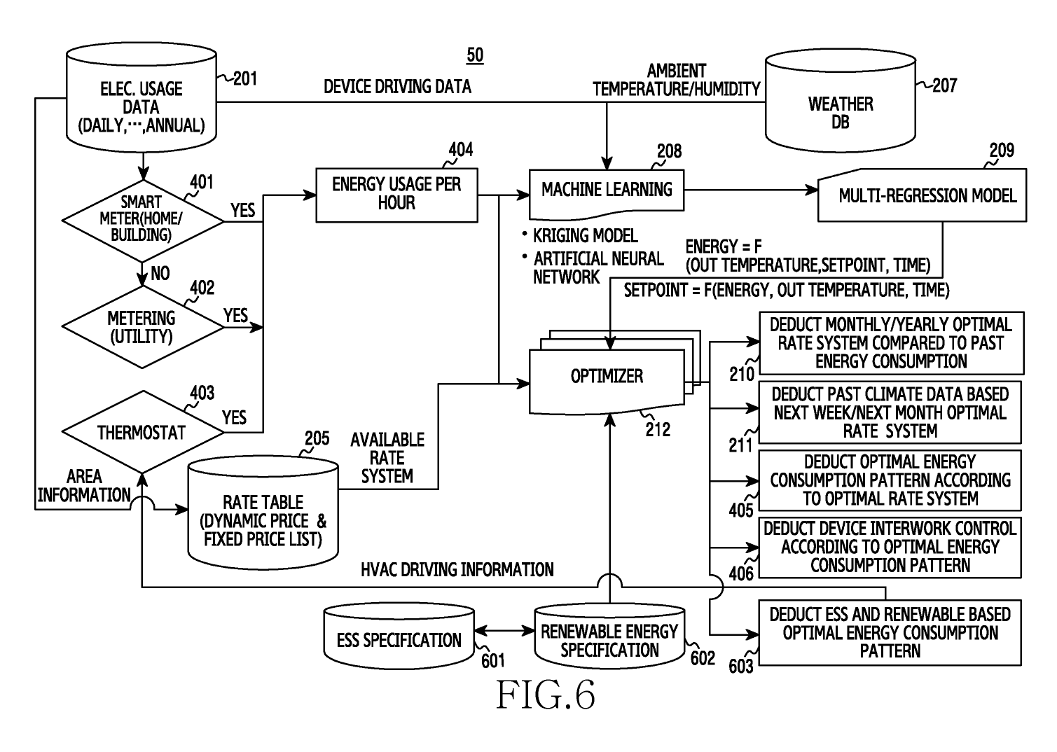

FIG. 6 is a diagram illustrating an example of a process of determining a renewable energy based optimal rate system. Some elements in FIG. 6 are described above regarding FIGS. 2 and 4 and may not be described again. In order to interwork with renewable energy (602), Energy Storage System (ESS) equipment (601) for storing energy is installed. Generally, the ESS, a Power Control System (PCS), which is a power control apparatus, and an Energy Management System (EMS) are configured together. Herein, the ESS is a supply such as a battery and calculates a Return On Investment (ROI) to be applied to a system when actually connecting with renewable energy because a price and a life depend on the number of times of charge/discharge, a charge/discharge speed, and battery materials. That is, unconditional numerous charge/discharge and fast charge/discharge are not the best, and an optimal control considering an energy rate and an investment cost is required. According to this, energy cost can be reduced using the ESS during a maximum load (high cost). Herein, there is solar energy as an example of renewable energy.

The smart system 50 according to an exemplary embodiment utilizes renewable energy through a cost minimization control technique which connects a charge/discharge time, amount, and speed to the ESS on the basis of climate based renewable energy regression model. For example, the smart system 50 according to an exemplary embodiment may determine an optimal energy consumption pattern (603) on the basis of the regression model using the ESS (601) and the renewable energy data (602). Further, the smart system 50 may detect energy usage data per hour using information on real-time power usage, rate system table information, and external temperature information as rate information. The smart system 50 deducts a monthly/yearly optimal rate system compared to past energy consumption on the basis of a regression model using the detected energy usage data. Further, the smart system 50 may deduct next week/next month optimal rate system according to past climate information additionally using climate information. Information on the real-time power usage may include energy usage, which is energy consumed by smart meter, metering, or thermostat, per hour. The rate system table may be selected or configured on the basis of consumer's area information. For example, the rate system table may include a rate system policy of an operator according to a consumer's area. Herein, the rate system policy may include detailed rate system policy for a flexible rate system and a fixed rate system.

Further, the smart system 50 in FIG. 6 may include an optimizer (212) in order to determine optimal energy consumption patterns corresponding to an optimal rate system and deduct interworking control information for controlling an operation of a device on the basis of the optimal energy consumption patterns. Herein, the device may refer to all devices which consume energy. According to an exemplary embodiment, the smart system 50 may determine at least one rate system of the fixed rate system and/or the flexible rate system as an optimal rate system by a rate system determination scheme as shown in FIG. 6. In addition, according to an exemplary embodiment, the smart system 50 may determine an optimal rate system by additionally considering a promotion rate system and/or a penalty rate system. For example, an optimal rate system determined in the smart system 50 may be a fixed rate system to which at least one of the promotion rate system and/or the penalty rate system is applied or a flexible rate system to which at least one of the promotion rate system and/or the penalty rate system is applied.

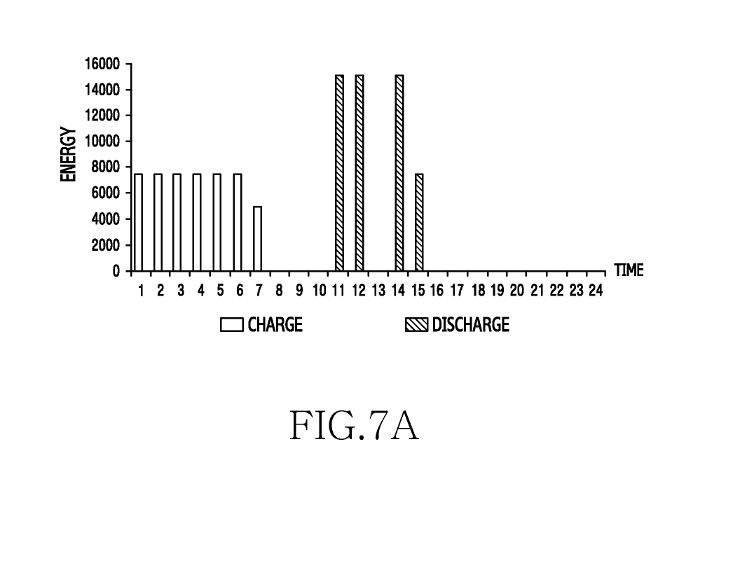

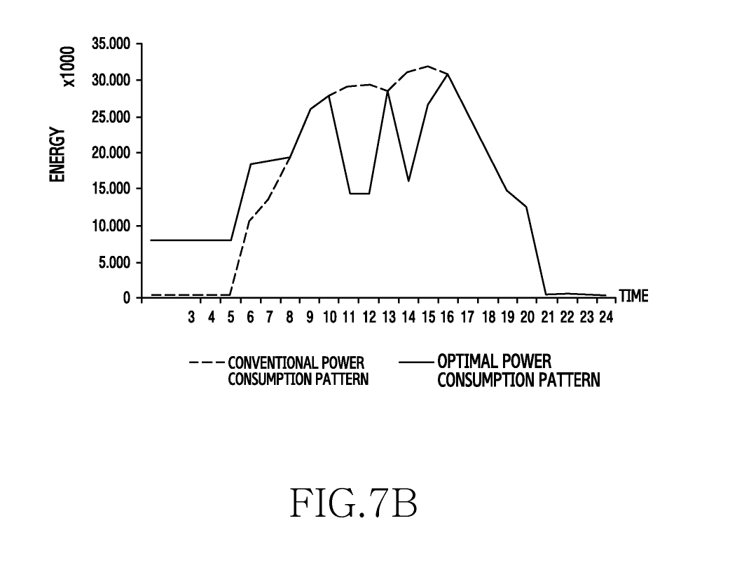

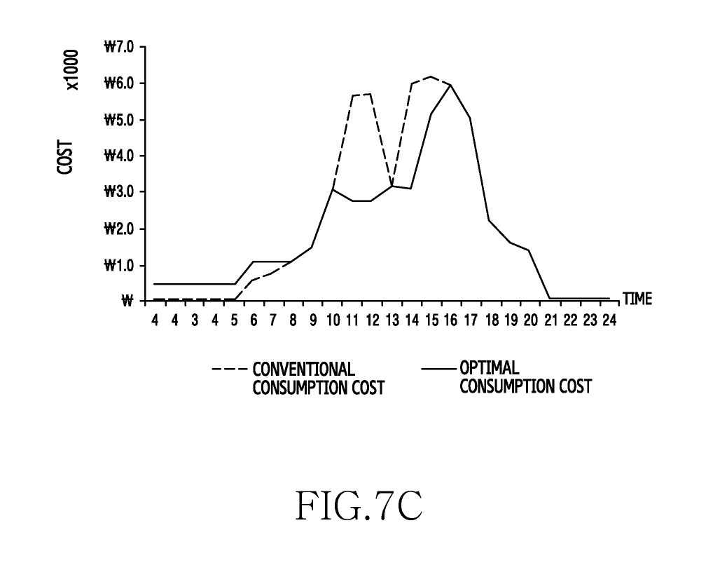

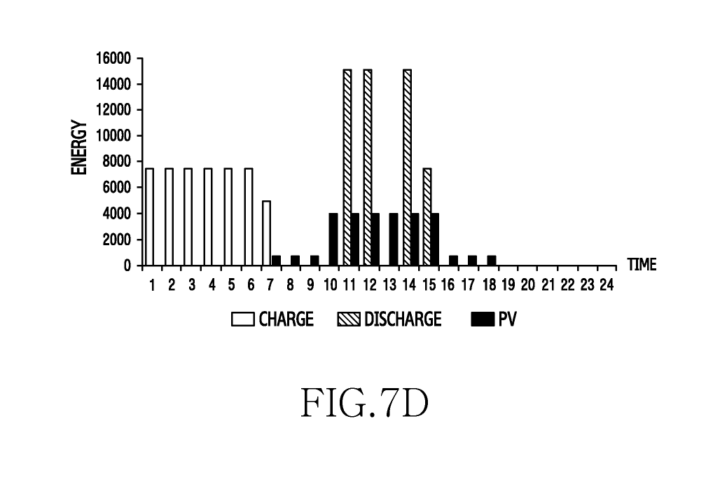

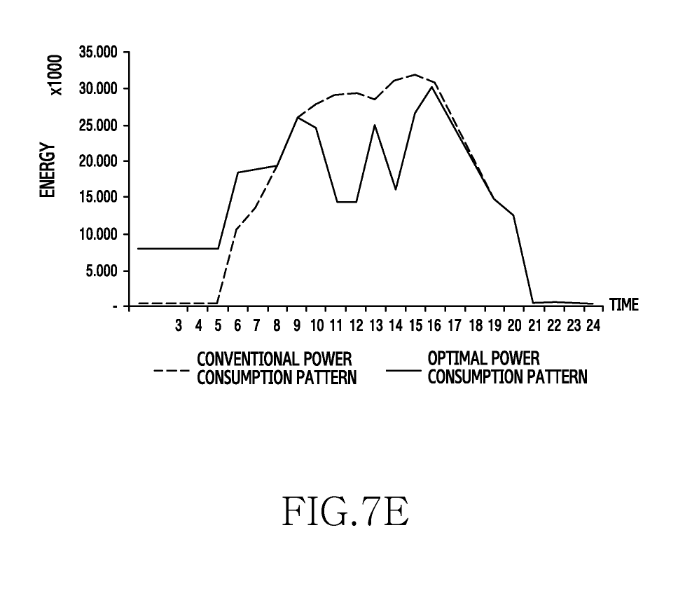

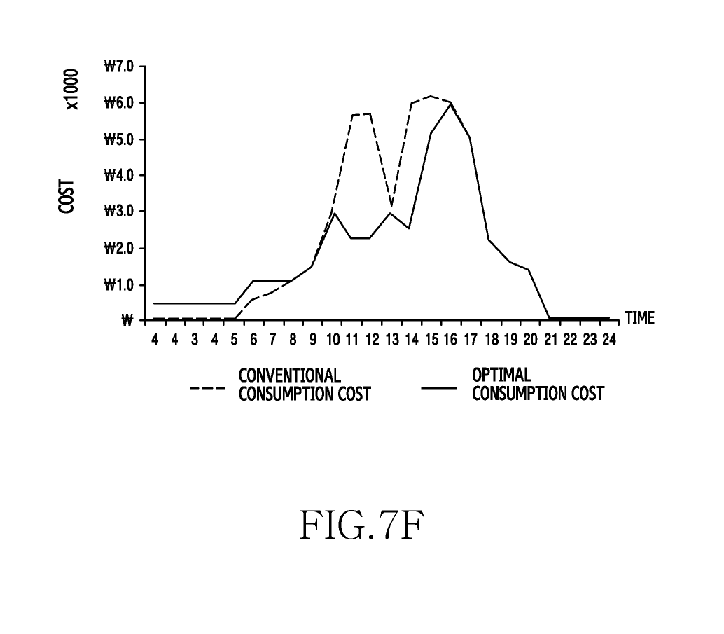

FIGS. 7A to 7F are diagrams illustrating a simulation result according to a determination of a fixed or flexible rate system as shown in FIG. 6. On the basis of recommended optimal rate system, an optimal energy consumption pattern when applying an Energy Storage System (ESS) is deducted. FIG. 7A is a diagram illustrating an example of an ESS charge/discharge system. FIG. 7B is a diagram illustrating an optimal rate system based power consumption pattern according to time, and FIG. 7C is a diagram illustrating cost reduction according to time in FIG. 7B. For example, FIGS. 7B and 7C illustrate that a cost reduction effect can be obtained by minimizing power consumption at 12 noon.

FIGS. 7D to 7F are diagrams which deduct an optimal energy consumption pattern when applying the ESS and the renewable energy (PV) on the basis of an optimal rate system recommendation. FIG. 7D is a diagram illustrating an optimal ESS charge/discharge and a Photovoltaic (PV) energy system. FIGS. 7E and 7F are diagrams illustrating an energy consumption pattern according to time and a cost according to time period on the basis of an optimal rate system. For example, FIGS. 7E and 7F illustrate that a cost reduction effect can be obtained by minimizing power consumption at 12 noon.

Hereinafter, an algorithm for implementation according to one or more exemplary embodiments will be described.

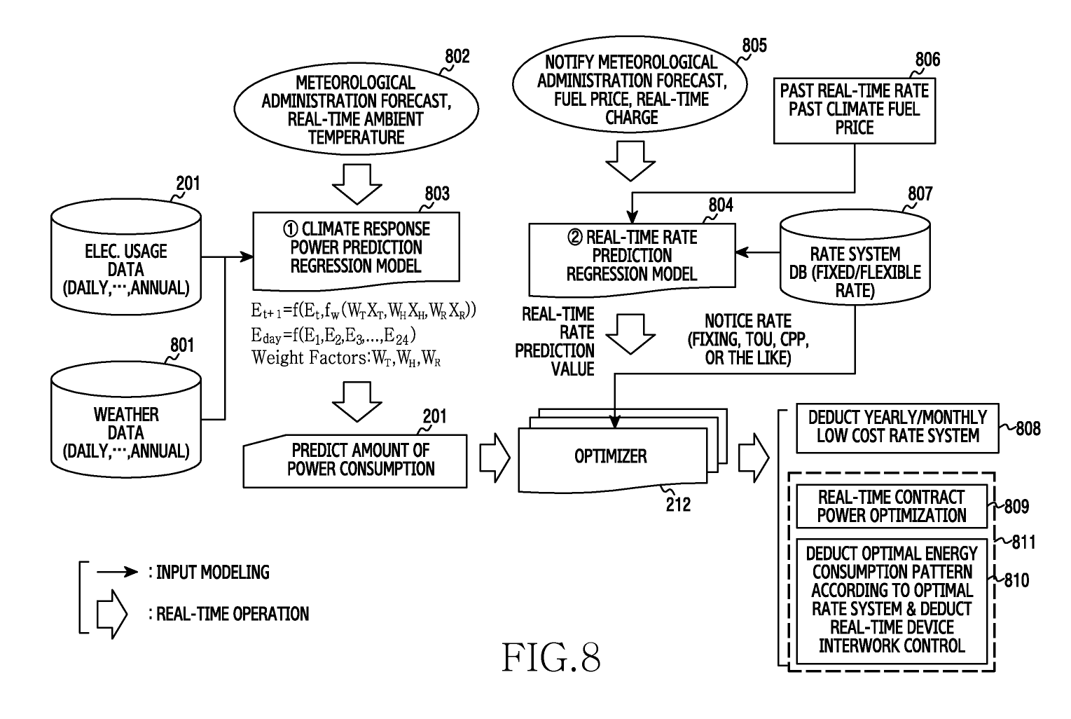

FIG. 8 is a diagram illustrating a modeling method for optimization of power consumption according to an exemplary embodiment. The method may utilize electricity usage data (201), weather data (801), meteorological administration forecast (802), notifying meteorological administration forecast (805), and rate system database (807). According to FIG. 8, a climate response power prediction regression model (803), a real-time rate prediction regression model (804), and an optimal model (811) are illustrated, respectively.

The climate response power prediction regression model relates to an uncertainty response method for an abnormal climate and a forecast mistake and error.

The climate response power prediction regression model reduces a sensitivity of a climate by considering an uncertainty factor (e.g., temperature, humidity, and the amount of sunshine), which generates in a climate-based building consumption power amount prediction so that power amount prediction accuracy is improved. Equation (1) below is a formula for obtaining a power energy prediction value according to a climate response power prediction regression model.

Eₜ₊₁=f(Eₜ,f_{w}(W_{T}X_{T}, W_{H}X_{H}, W_{R}X_{R}))

E_{day}=(E₁, E₂, E₃, . . . , E₂₄), Δt=t+1−t=1ₕₒᵤᵣ

f_{w}(W_{T}X_{T}, W_{H}X_{H}, W_{R}X_{R}, . . . )=W_{T}X_{T}+W_{H}X_{H}+W_{R}X_{R}+ . . . (1)

Herein, Eₜ₊₁ refers to a prediction power of a next time zone according to the power prediction regression model and E_{day} refers to a prediction power according to a power prediction regression model for each time zone for a day. In addition, Eₜ may refer to a prediction power of a present time zone. Further, f_{w} may refer to weights to which climate information is applied.

Meanwhile, herein, X_{T} refers to a temperature, X_{H} refers to humidity, X_{R} refers to the amount of sunshine, W_{T} refers to a temperature weight, W_{H} refers to a humidity weight, and W_{R} refers to a sunshine amount weight.

An example of a reference table of each variable for a climate response model is shown in Table 1 below.

TABLE 1

| | XT | XH | XR |
|---|---|---|---|
| Past monthly/seasonal | x_{T1} | x_{H1} | x_{R1} |
| meteorological administration | | | |
| information | | | |
| Day meteorological | x_{T2} | x_{H2} | x_{R2} |
| administration forecast | | | |
| information | | | |
| Real-time ambient | x_{T3} | x_{H3} | x_{R3} |
| information | | | |
| Past meteorological | x_{T4} | x_{H4} | x_{R4} |
| administration information by | | | |
| each time zone | | | |

Equation (2) below is obtained by calculating f_{w}(W_{T}X_{T}, W_{H}X_{H}, W_{R}X_{R}, . . . ) by referring to Table 1.

$${f}_{w} ( {W}_{T} {X}_{T} , {W}_{H} {X}_{H} , {W}_{R} {X}_{R} , … ) = {W}_{T} {X}_{T} + {W}_{H} {X}_{H} + {W}_{R} {X}_{R} + … = [ {α}_{T} , {β}_{T} , {γ}_{T} ] [ \begin{matrix}{x}_{{t}_{1}} \\ {x}_{{t}_{2}} \\ {x}_{{t}_{3}}\end{matrix} ] + [ {α}_{H} , {β}_{H} , {γ}_{H} ] [ \begin{matrix}{x}_{{h}_{1}} \\ {x}_{{h}_{2}} \\ {x}_{{h}_{3}}\end{matrix} ] + [ {α}_{R} , {β}_{R} , {γ}_{R} ] [ \begin{matrix}{x}_{{r}_{1}} \\ {x}_{{r}_{2}} \\ {x}_{{r}_{3}}\end{matrix} ] + … \qquad ( 2 )$$

Values corresponding to weights in equation (2) may be calculated through equation (3) below.

$${W}_{T} = [ {α}_{T} , {β}_{T} , {γ}_{T} ] \\ {W}_{H} = [ {α}_{H} , {β}_{H} , {γ}_{H} ] \\ {W}_{R} = [ {α}_{R} , {β}_{R} , {γ}_{R} ] \\ {X}_{T} = [ \begin{matrix}{x}_{{t}_{1}} \\ {x}_{{t}_{2}} \\ {x}_{{t}_{3}}\end{matrix} ] {X}_{H} = [ \begin{matrix}{x}_{{h}_{1}} \\ {x}_{{h}_{2}} \\ {x}_{{h}_{3}}\end{matrix} ] {X}_{R} = [ \begin{matrix}{x}_{{r}_{1}} \\ {x}_{{r}_{2}} \\ {x}_{{r}_{3}}\end{matrix} ] \qquad ( 3 )$$

FIG. 9 is a flowchart of an exemplary embodiment illustrating a climate response power prediction regression model. In FIG. 9, there are climate-related weights W₁(α₁, β₁, γ₁), past monthly/seasonal meteorological administration information (x_{T}_{₁} x_{H}_{₁} x_{R}_{₁}), day meteorological administration information (x_{T}_{₂} x_{H}_{₂} x_{R}_{₂}), real-time ambient information (x_{T}_{₃} x_{H}_{₃} x_{R}_{₃})α₁+β₁+γ₁=1, a past monthly/seasonal temperature history, and a day meteorological administration temperature standard deviation in 3 hours unit σₓ_{_{t2 3 hours}} are determined (S901).

According to FIG. 9, when an ambient temperature does not belong to a normal range (S902:N), a weight applied to a climate response power prediction regression model applies a weight according to abnormal climate (S905). Meanwhile, if an ambient temperature belongs to a normal range (S902:Y), when a climate forecast belongs to a normal range (S903:Y), a weight applied to the climate response power prediction regression model applies a weight which belongs to a meteorological administration forecast error range (S904). Further, when the climate forecast is out of the normal range (S905:N), a weight applied to the climate response power prediction regression model applies a weight which belongs to a meteorological administration forecast error range (S906). According to various exemplary embodiments, a performance order of a process of determining an ambient temperature normal range and a process of determining a climate forecast normal range is changed so that it may be determined whether there is an abnormal climate in each process and may apply the climate response power prediction regression model by varying a weight according to this.

The real-time rate prediction regression model 804 of FIG. 8 relates to a scheduling optimization method according to a real-time rate change. In a case of a short-term (1 hour) rate notice, it may be difficult to predict an optimal scheduling of a next whole day. Therefore, the real-time rate prediction regression model is needed to implement an optimal rate system when a smart grid is introduced and can be used to calculate a real-time rate prediction through real-time rate data according to past time zone, climate information of the time, and fuel cost information 806. In this event, a statistical model prediction is used. Equation (4) below is a formula for obtaining a real-time rate prediction value according to a real-time rate prediction regression model.

C_{t,d-1}=f_{RTP1}(C_{t,d}, C_{RTP,d+1}, f_{w}(W_{T}X_{T}, W_{H,}X_{H}, W_{R}X_{R})_{t,d+1}, E_{t,d}), t∈[1:24] (4)

Herein, C_{t,d+1} refers to a prediction rate according to a rate prediction regression model, d refers to a predetermined period since the day before prediction, C_{t,d} refers to a predetermined period real-time rate according to a past time zone, C_{RTP,d+1} refers to a present real-time rate, f_{w}(W_{T}X_{T}, W_{H}X_{H}, W_{R}X_{R})_{t,d+1} refers to climate information according to a past time zone and real-time time zone, and E_{t,d} refers to energy information according to a past power company time zone.

In addition, equation (5) below is another formula for obtaining a real-time rate prediction value according to a real-time rate prediction statistical model. When a statistical model based prediction value is out of a predetermined range, a real-time prediction rate statistical model of equation (5) is applied as a rate prediction scheme based on a real-time rate of the day.

C_{t,d+1}=f_{RTP2}(C_{RTP,d+1}, E_{t,d}) (5)

Herein, C_{t,d+1} refers to a prediction rate according to a rate prediction statistical model, C_{RTP,d+1} refers to a present real-time rate, and E_{t,d+1} refers to energy information according to a time zone of a present power company. Herein, t corresponds to t ∈ [1:24].

Equation (4) or (5) as described above is applied according to whether a real-time prediction rate according to a regression model based prediction is within a predetermined range (σ).

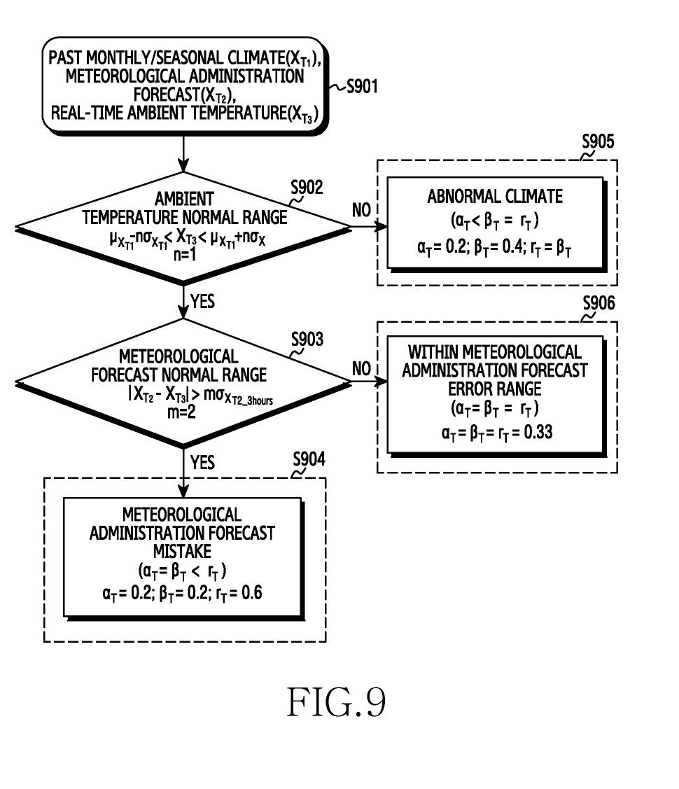

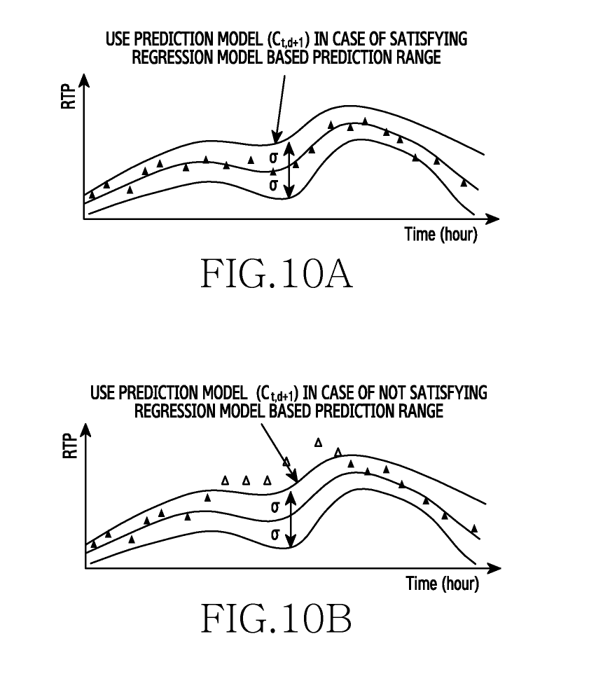

FIGS. 10A and 10B are reference diagrams illustrating an example of a real-time rate prediction regression model. FIG. 10A illustrates an example of using the real-time rate prediction regression model of equation (4) based on a power value according to a time zone and a real-time rate value of a past power company when a regression model based prediction value belongs to a predetermined range (σ), and FIG. 10B illustrates an example of using the real-time rate prediction statistical model of equation (5) as a real-time rate of the day based rate prediction scheme when a regression model based prediction value is out of a predetermined range (σ). An optimal model relates to a method of satisfying a global optimal for each variable. However, exemplary embodiments allow an optimal variable value according to a combination of a variable having a big influence among variables and a dominant factor, unlike conventional separate optimization, order optimization, or single objective optimization. To this end, a calculation time for optimization may be reduced. For example, a method of optimizing three values y₁, y₂ and y₃ will be described. Herein, it is assumed that y₁ is a yearly/monthly low cost rate system optimization value (808, FIG. 8), y₂ is a real-time contract power optimization value (809, FIG. 8), and y₃ is a real-time low cost consumption pattern optimization value (810, FIG. 8). The method described hereinafter corresponds to a methodology for combining variables having a large influence on y₁, y₂, and y₃, among variables on an identical domain, and dominant factors y*₁, y*₂, and y*₃ of each y₁, y₂, and y₃.

Y=f(charging system variable, contract power variable, consumption pattern variable) (6)

Herein, Y refers to an optimization value for each of three values. A rate system variable may exemplify [Tier(t), TOU(t), CPP(t), RTP(t)] and combine these rate systems. Further, a contract power variable may exemplify [HVAC(t), Lighting(t), Appliance(t)] corresponding to [an HVAC, an illuminator, other appliances according to a time zone]. In addition, a consumption pattern variable may exemplify [Occupancy(t), Zone Setpoint(t), Room Temp(t)] corresponding to [occupants according to a time zone, an HVAC configuration temperature applied to each space, a indoor temperature of each space]. Herein, t corresponds to t ∈ [1:24].

For example, it may be assumed that y₁ is a value for yearly/monthly low cost rate system optimization, y₂ is a value for real-time contract power optimization, and y₃ is a value for real-time low cost consumption pattern optimization. Calculating formula of y₁, y₂, and y₃ according to equation (6) is obtained by equation (7) below.

y_{1,t}=f(x_{1,t}, x_{2,t}, x_{3,t}, x*_{4,t-1}, x*_{5,t-1}, x*_{6,t-1}, x*_{7,t-1}, x*_{8,t-1}, x*_{9,t-1})

y_{2,t}=f(x*_{1,t-1}, x*_{2,t-1}, x*_{3,6-1}, x_{4,t}, x_{5,t}, x_{6,t}, x*_{7,t-1}, x*_{8,t-1}, x*_{9,t-1})

y_{3,t}=f(x*_{1,t-1}, x_{2,t-1}, x*_{3,t-1}, x*_{4,t-1}, x*_{5,t-1}, x*_{6,t-1}, x_{7,t}, x_{8,t}, x_{9,t}) (7)

Herein, y_{1,t} refers to a low cost rate system optimization value, x_{1,t}, x_{2,t}, x_{3,t} refer to contract power variables in t time, x*_{4,t-1}, x*_{5,t-1}, x*_{6,t-1} correspond to constant values corresponding to rate system dominant factors in t−1 time, and x*_{7,t-1}, x*_{8,t-1}, x*_{9,t-1} refer to constant values corresponding to consumption pattern dominant factors in t−1 time.

Further, herein, y_{2,t} refers to a contract power optimization value, x_{4,t}, x_{5,t}, x_{6,t} refer to constant values corresponding to contract power variables in t time, x*_{1,t-1}, x*_{2,t-1}, x*_{3,t-1} correspond to constant values corresponding to rate system dominant factors in t−1 time, and x*_{7,t-1i}, x*_{8,t-1}, x*_{9,t-1} refer to constant values corresponding to consumption pattern dominant factors in t−1 time.

In addition, herein, y_{3,t} refers to a consumption pattern optimization value, x_{7,t}, x_{8,t}, x_{9,t} correspond to consumption pattern variables in a t time, x*_{1,t-1}, x*_{2,t-1}, x*_{3,t-1} refer to constant values corresponding to rate system dominant factors in a t−1 time, and x*_{4,t-1}, x*_{5,t-1}, x*_{6,t-1} refer to constant values corresponding to contract power dominant factors in a t−1 time.

Herein, t and t−1 refer to each step in which an optimal algorithm is operated.

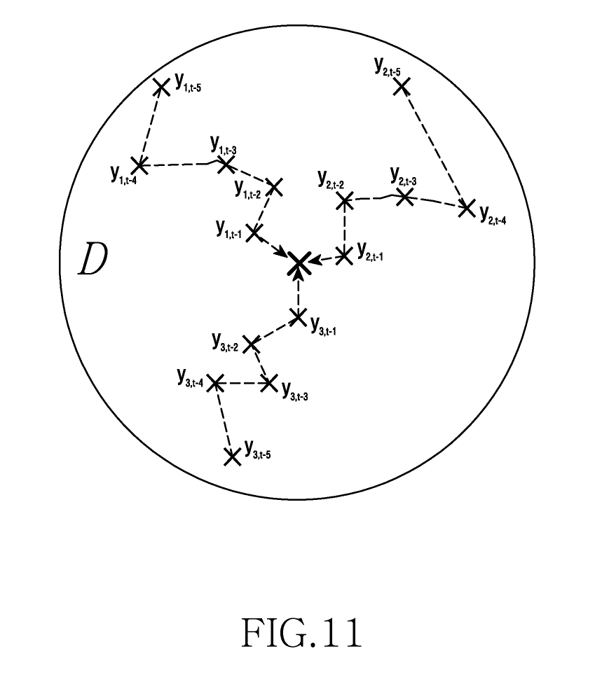

FIG. 11 is a reference diagram illustrating an example of an optimal model according to equation (7). As noted from FIG. 11, a low cost rate system optimization value, a contract power optimization value, a consumption pattern optimization value, which are calculated in each time period (point), converge on values satisfying y_{1,t}, y_{2,t}, y_{3,t}, respectively. That is, low cost rate system optimization y₁=min(power rate cost)=min(f(TOU, CPP, RTP(t)), energy pattern based contract power optimization y₂=min(contract power)=min(f(HVAC(t), Lighting(t), Appliance(t)), and device control based low cost consumption pattern optimization y₃=min(low cost consumption pattern)=min(f(Occu.(t), ZoneS.P(t), RTemp(t)), which are repeatedly calculated, converge on values satisfying with a low cost rate system optimization value, a contract power optimization value, and a consumption pattern optimization value, respectively.

Meanwhile, an optimal electricity rate system or an optimal power consumption pattern may be determined using ESS information and renewable energy information other than a grid power. To this end, the ESS information and renewable energy information as shown in equation (8) below may be used.

Renewable Energyₜ₋₁=f(Out Temp.(t), Wind Speed(t), Radiation(t))ESS=F(Electricity Rate(t), Renewable Energy(t), E_{day}, ESS_{lifecycle} ESS_{charging rate}) (8)

Herein, Out Temp(t) refers to an external temperature, Wind Speed(t) refers to a speed of wind, Radiation(t) refers to the amount of sunshine, Electricity Rate(t) refers to a power rate, E_{day} refers to a consumption power according to a consumption power regression model, ESS_{lifecycle} refers to a life period of the ESS, and ESS_{chargingrate} refers to a charging rate of the ESS.

Herein, the ESS may be supplies, such as a battery, and calculates a Return On Investment (ROI) to be applied to a system when actually connecting with renewable energy because a price and a life depend on the number of times of charge/discharge, a charge/discharge speed, and battery materials. That is, an optimal control considering an energy rate and an investment cost is required and renewable energy is utilized through a cost minimization control technique which connects a charge/discharge time, amount, and speed to the ESS on the basis of climate based renewable energy regression model.

Meanwhile, device control information is detected on a device (e.g., HVAC) providing an energy service using a real-time low cost consumption pattern obtained by the optimization model. In detecting the device control information, equation (9) below is used.

Setpointₜ₊₁=f(ΔTemp(t), Room Temp.(t), Occupancy(t), E_{day}) (9)

Herein, Setpoint refers to the device control information, ΔTemp.(t) value is the difference between an external temperature and an indoor temperature and can adjust air conditioning and heating according to ΔTemp.(t). Therefore, a device is controlled to allow ΔTemp.(t) to be larger than or equal to a proper positive number in summer, and a device is controlled to allow ΔTemp.(t) to be less than or equal to a proper negative number in winter.

A configuration temperature (Setpoint) is calculated on the basis of an ambient temperature based consumption power regression model in a past year or a predetermined period and multivariable regression model with deducted consumption power, indoor temperature, occupant information, and ΔTemp.(t). That is, a consumption pattern based device interwork control value may be deducted through a multi-regression model. A machine learning methodology such as polynomial regression (e.g., Kriging Model), Artificial Neural Network (ANN), and Support Vector Regression (SVR), may be used as the regression model.

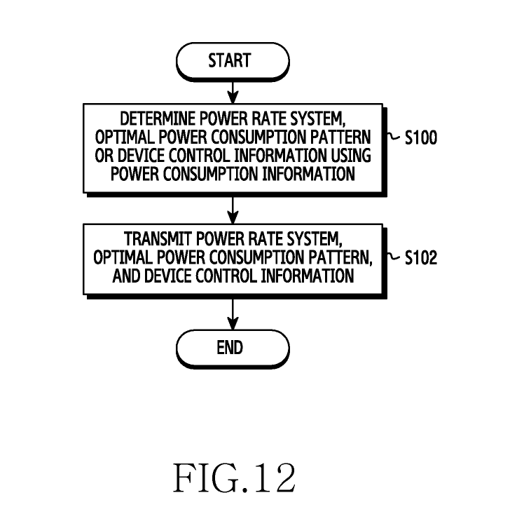

FIG. 12 is a flowchart illustrating an exemplary embodiment of an operation method of a smart system for optimization of power consumption according to an exemplary embodiment.

On the basis of power consumption information including rate information according to power use of a consumer and real-time power use information used by the consumer, an optimal electricity rate system corresponding to the consumer is determined in step S100. In addition, an optimal power consumption pattern for minimizing power consumption of the consumer is determined using the determined electricity rate system. Further, device control information on a device providing an energy service is determined using the determined optimal power consumption pattern.

The rate information includes rate receipts and rate transfer information according to a period of the consumer.

Also, climate information may further be included as the power consumption information. Herein, the climate information may include meteorological information provided in ambient temperature, a wind speed, and the amount of sunshine.

Further, at least one of Energy Storage System (ESS) information and renewable energy information may further be included as the power consumption information. The ESS information and the renewable energy information are obtained by equation (8) as described above. That is, for the ESS information and the renewable energy information, Out Temp(t) refers to an external temperature, Wind Speed(t) refers to a speed of wind, Radiation(t) refers to the amount of sunshine, Electricity Rate(t) refers to a power rate, E_{day} refers to a consumption power according to a consumption power regression model, ESS_{lifecycle} refers to a life period of the ESS, and ESS_{chargingrate} refers to a charging rate of the ESS.

A kind of optimal electricity rate systems includes a fixed rate system or a flexible rate system. The fixed rate system does not have price fluctuation according to a usage and a using time and is free from a risk of price fluctuation according to climate, market, and economy. There is a Tier-based rate system as an example of the fixed rate system.

The flexible rate system may be at least one of a TOU-based rate system, a CPP-based rate system, an RTP-based rate system. In the TOU-based rate system, according to a power demand, there is a scheme (double shifts or three shifts) in which rates are different according to a time zone of a day and a scheme in which weekdays and weekend rates are different. The TOU-based rate system is applied to a large scale consumer rate and is applied according to a seasonal power demand. The CPP-based rate system applies a peak level power price in a time zone in which a power demand is high, and may be applied in only the limited time throughout the year in parallel with the TOU-based rate system. The RTP-based rate system is that a price is changed in a real-time unit to apply the changed price and an electric rate is changed in a predetermined time (e.g., minimum 5 minutes, one hour, or the previous day). The rate system is applied to price fluctuations (fuel price fluctuations, operation, and power supply and demand situation) of wholesale/retail market and fluctuations of an electronic rate is high but the benefit of both an operator and a consumer increases when the consumer economically uses.

A fixed rate system and a flexible rate system according to an exemplary embodiment are divided according to whether a rate for a unit power is changed with respect to a specific time section. For example, a rate system where a rate for a unit power is not changed for 24 hours corresponding to one day may be referred to as a fixed rate system and a rate system where a rate for a unit power is changed for 24 hours may be referred to as a flexible rate system. Therefore, in the fixed rate system and the flexible rate system, the rate for the unit power may be changed by an external factor (e.g., oil price fluctuations).

Additionally, according to an exemplary embodiment, a rate system determined by various regression models may be a rate system in a type of combining two or more rate systems among the fixed rate systems and/or flexible rate systems. In addition, according to an exemplary embodiment, a rate system determined by various regression models may be a rate system in a type in which a promotion rate system and/or a penalty rate system designed by each operator is combined with the fixed rate systems and/or flexible rate systems. Herein, the promotion rate system may be a rate system which discounts a rate for each unit power in a specific time zone. In addition, the penalty rate system may be a rate system which adds an additional rate to a rate for each unit power when the amount of power use is larger than or equal to a threshold amount in a specific time period. The penalty rate system may be a rate system which discounts a rate for each unit power or adds an additional rate to a rate for each unit power when the amount of the power use in a specific period is less than or equal to or is larger than or equal to a threshold amount selected by a consumer.

The determination of the electricity rate system determines an optimal electricity rate system using power consumption data according to a period such as year or month. Also, the determination of the electricity rate system configures a rate prediction regression/statistic model using the real-time power use information and determines an optimal electricity rate system corresponding to the configured rate prediction regression/statistical model. The rate prediction regression/statistic model is configured using equation (4) or (5). Herein, C_{t,d+1} refers to a prediction rate according to a rate prediction regression model, d refers to a predetermined period since the day before prediction, C_{t,d} refers to a predetermined period real-time rate according to a past time zone, C_{RTP,d+1} refers to a present real-time rate, f_{w}(W_{T}X_{T}, W_{H}X_{H}, W_{R}X_{R})_{t,d+1} refers to climate information according to past and real-time time zones, E_{t,d} refers to energy information according to past power company time zone, and E_{t,d+1} refers to energy information according to a time zone of a present power company.

Equation (4) or (5), as described above, is applied according to whether a real-time prediction rate according to a regression/statistic model based prediction is satisfied within a predetermined range (σ). FIG. 10A illustrates an example of using the real-time rate prediction regression model of equation (4) based on a power value according to a time zone and a real-time rate value of a past power company when a regression model based prediction value belongs to a predetermined range (σ) and FIG. 10B illustrates an example of using the real-time rate prediction statistical model of equation (5) as a real-time rate based rate prediction scheme when a regression model based prediction value is out of a predetermined range (σ).

When climate information has been collected as the power consumption information, the electricity rate system is determined using the collected climate information. To this end, a prediction regression model is configured using the climate information and the electricity rate system corresponding to the configured power prediction regression model.

The power prediction regression model is configured using equation (1) as described above. In this event, in equation (1), Eₜ₊₁ refers to a prediction power according to the power prediction regression model, X_{T} refers to a temperature, X_{H} refers to humidity, the X_{R} refers to the amount of sunshine, W_{T} refers to a temperature weight, W_{H} refers to a humidity weight, and W_{R} refers to a sunshine amount weight. Though equations (2) and (3) as described above, a value corresponding to each weight may be calculated.

Herein, the temperature weight, the humidity weight, and the sunshine amount weight of the power prediction regression model is configured by considering at least one of whether an ambient temperature belongs to a normal range and whether a meteorological forecast belongs to a normal range. That is, as shown in FIG. 9, when the ambient temperature does not belong to the normal range, a weight applied to the climate response power prediction regression model applies a weight according to an abnormal climate. Meanwhile, under a condition in that ambient temperature belongs to a normal range, when a climate forecast belongs to a normal range, a weight applied to the climate response power prediction regression model applies a weight which belongs to a meteorological administration forecast error range. Further, when the climate forecast is out of the normal range, a weight applied to the climate response power prediction regression model applies a weight which belongs to a meteorological administration forecast error.

In addition, when Energy Storage System (ESS) information or renewable energy information has been collected as power consumption information, the electricity rate system is determined using the power consumption information including the ESS information or the renewable energy information. The ESS information and renewable energy information as shown in equation (8) as described above are used. That is, in equation (8), as the ESS information and the renewable energy information, Out Temp(t) refers to an external temperature, Wind Speed(t) refers to a speed of wind, Radiation(t) refers to the amount of sunshine, Electricity Rate(t) refers to a power rate, E_{day} refers to a consumption power according to a consumption power regression model, ESS_{lifecycle} refers to a life period of the ESS, and ESS_{chargingrate} refers to a charging rate of the ESS.

The ESS may be supplies, such as a battery, and calculates a Return On Investment (ROI) when actually connecting with renewable energy because a price and a life depend on the number of times of charge/discharge, a charge/discharge speed, and battery materials to be applied to a system. That is, an optimal control considering an energy rate and an investment cost is required and renewable energy is utilized through a cost minimization control technique which connects a charge/discharge time, amount, and speed to the ESS on the basis of climate based renewable regression model.

Then, an optimal power consumption pattern for minimizing power consumption of the consumer is determined using the determined electricity rate system. The optimal power consumption pattern is determined using equation (6). Herein, Y corresponds to one of an electricity rate system optimization value, a real-time contract power optimization value, and a real-time consumption pattern optimization value. Also, a rate system variable can exemplify [Tier(t), TOU(t), CPP(t), RTP(t)] and combine these rate systems. Further, a contract power variable may exemplify [HVAC(t), Lighting(t), Appliance(t)] corresponding to [an HVAC, an illuminator, other appliances according to a time zone]. In addition, a consumption variable may exemplify [Occupancy(t), Zone Setpoint(t), Room Temp(t)] corresponding to [occupants according to a time zone, an HVAC configuration temperature applied to each space, a indoor temperature of each space]. Herein, t corresponds to t ∈ [1:24].

The Y configures one of the electricity rate system variable, the contract power variable, and the consumption pattern variable as a variable in present time, and remaining variables are replaced with constant value according to dominant factors in previous time to be calculated.

For example, a method of optimizing three values y₁, y₂ and y₃ will be described. Herein, it is assumed that y₁ is a yearly/monthly low cost rate system optimization value, y₂ is a real-time contract power optimization value, and y₃ is a real-time low cost consumption pattern optimization value. Calculating formula of y₁, y₂ and y₃ according to equation (6) is obtained by equation (7) as described above. y_{1,t} refers to a low cost rate system optimization value, x_{1,t}, x_{2,t}, x_{3,t} correspond to a rate system variable in t time, x*_{4,t-1}, x*_{5,t-1}, x*_{6,t-1} refer to constant values corresponding to contact power dominant factors in t−1 time, and x*_{7,t-1}, x*_{8,t-1}, x*_{9,t-1} refer to constant values corresponding to consumption pattern dominant factors in t−1 time. In addition, y_{2,t} refers to a contract power optimization value, x*_{4,t-1}, x*_{5,t-1}, x*_{6,t-1} refer to constant values corresponding to contract power dominant factors in a t−1 time, x*_{1,t-1}, x*_{2,t-1}, x*_{3,t-1} refer to constant values corresponding to rate system dominant factors in a t−1 time, and x_{7,t}, x_{8,t}, x_{9,t} correspond to consumption pattern variables in a t time. In addition, y_{3,t} refers to a consumption pattern optimization value, x_{7,t}, x_{8,t}, x_{9,t} correspond to consumption pattern variables in a t time, x*_{1,t-1}, x*_{2,t-1}, x*_{3,t-1} refer to constant values corresponding to rate system dominant factors in a t−1 time, and x*_{4,t-1}, x*_{5,t-1}, x*_{6,t-1} refer to constant values corresponding to contract power dominant factors in a t−1 time. Herein, t and t−1 refer to each step in which an optimal algorithm is operated.

As noted from FIG. 11, a low cost rate system optimization value, a contract power optimization value, and a consumption pattern optimization value, which are calculated in each time period (point), converge on values satisfying y_{1,t}, y_{2,t}, y_{3,t}, respectively. That is, low cost rate system optimization y₁=min(power rate cost)=min(f(TOU, CPP, RTP(t)), energy pattern based contract power optimization y₂=min(contract power)=min(f(HVAC(t), Lighting(t), Appliance(t)), and device control based low cost consumption pattern optimization y₃=min(low cost consumption pattern)=min(f(Occu.(t), ZoneS.P(t), RTemp(t)), which are repeatedly calculated, converge on values satisfying a low cost rate system optimization value, a contract power optimization value, and a consumption pattern optimization value. Herein, t corresponds to t ∈ [1:24].

Then, device control information on a device providing an energy service is determined using the determined optimal power consumption pattern. For example, information for a control of the HVAC may be determined on the basis of a power regression model, which connects power consumption data for the past one year or during a predetermined period and climate information, and a device control scheduling based setpoint calculation result.

In order to determine device control information, equation (9) as described above, may be used. Herein, Setpoint refers to the device control information, ΔTemp.(t) value is the difference between an external temperature and an indoor temperature and can adjust air conditioning and heating according to ΔTemp.(t). Therefore, a device is controlled to allow ΔTemp.(t) to be larger than or equal to proper positive number in summer, and a device is controlled to allow ΔTemp.(t) to be less than or equal to a proper negative number in winter. A configuration temperature (setpoint) is calculated on the basis of an ambient temperature based consumption regression model in a past year or predetermined period and multivariable regression model with deducted consumption power, indoor temperature, occupant information, and ΔTemp.(t). That is, a consumption pattern based device interwork control value may be deducted through a multi-regression model. A machine running methodology such as polynomial regression, ANN, and SVR may be used as the regression model.

After operation S100, determined optimal electricity rate system, optimal power consumption pattern, and device control information are transmitted to a consumer terminal or a consumer device in operation S102. The determined optimal electricity rate system and the optimal power consumption pattern are transmitted to the consumer terminal so that a rate system for minimizing power consumption may be selected on the basis of the information by a corresponding consumer or a device control for this may manually be performed. The device control information on the consumer device is transmitted to a consumer device (e.g., a TV, a air conditioner, a heater, or the like) so that a proper control for power optimization of a corresponding consumer device may be performed.

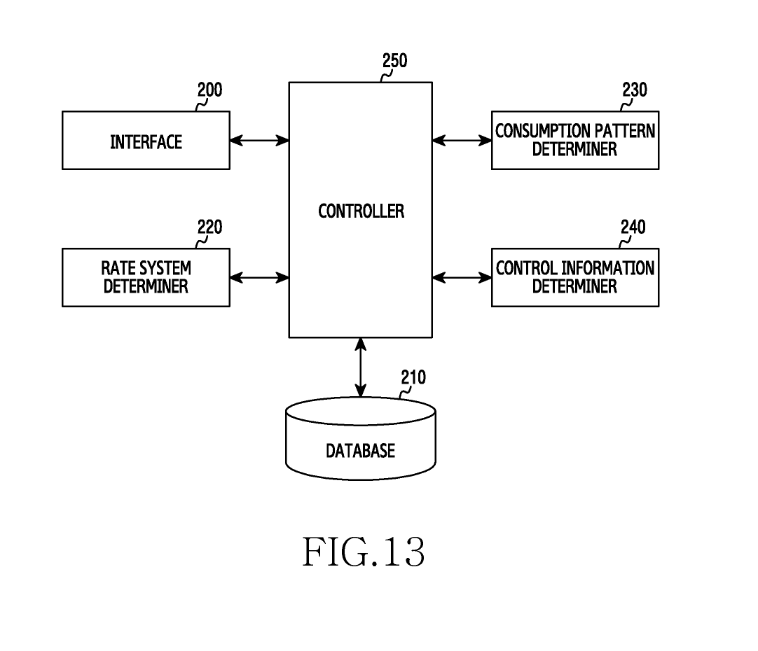

FIG. 13 is a block diagram for describing an exemplary embodiment of an operation device 50 of a smart system for optimization of power consumption according to an exemplary embodiment and includes an interface 200, a database 210, a rate system determiner 220, a consumption pattern determiner 230, a control information determiner 240, and a controller 250.

The interface 200 is connected to the consumer terminal 10, the power company 20, a meteorological administration 30, a consumer device 60, and a wired/wireless network 40 as shown in FIG. 1.

The interface 200 receives power consumption information including at least one of rate information according to a power use of a consumer and real-time power use information on which the consumer uses.

The interface 200 receives rate receipt and rate transfer information according to a period of the consumer as rate information and to this end, attempts an access through a consumer terminal or a power company and a wired/wireless network.

In addition, the interface 200 receives climate information as the power consumption information. The interface 200 attempts an access to the wired/wireless network providing a meteorological administration network or other climate information. Herein, the climate information includes meteorological information provided in ambient temperature, a wind speed, and an amount of sunshine.

Further, the interface 200 receives at least one of Energy Storage System (ESS) information and renewable energy information as the power consumption information. The interface 200 attempts an access to an ESS information and renewable energy information service device and the wired/wireless network. The ESS information and the renewable energy information include information such as an ambient temperature, a wind speed, the amount of sunshine, a power rate, a consumption power, a life cycle of the ESS, and a charging rate of the ESS. The database 210 stores power consumption information received in the interface 200, i.e., rate information according to power use of a consumer, real-time power use information, climate information, ESS information, and renewable energy information.

The rate system determiner 220 determines an electricity rate system corresponding to the consumer using the received power consumption information. The rate system determiner 220 determines one of a fixed rate system and a flexible rate system as the electricity rate system. The rate system determiner 220 determines an optimal electricity rate system using power consumption data according to a period such as year or month.

The rate system determiner 220 configures a rate prediction regression model using the real-time power use information and determines an optimal electricity rate system corresponding to the configured rate prediction regression model. The rate prediction regression/statistic model is configured using equation (4) or (5).

The rate system determiner 220 determines which model in equation (4) or (5) as described above is applied according to whether a real-time prediction rate depending on a regression model based prediction is satisfied within a predetermined range (σ). For example, as shown in FIG. 10A, the rate system determiner 220 uses the real-time rate prediction regression model of equation (4) based on a power value according to a time zone and a real-time rate value of a past power company when a regression model based prediction value belongs to a predetermined range (σ), and as shown in FIG. 10B, the rate system determiner 220 uses the real-time rate prediction statistical model of equation (5) as a real-time rate for one day based rate prediction scheme when a regression model based prediction value is out of a predetermined range (σ).

When climate information has been collected as the power consumption information, the rate system determiner 220 is determined using the collected climate information. The rate system determiner 220 is configured using the climate information and determines the electricity rate system corresponding to the configured power prediction regression model.

The rate system determiner 220 configures the power prediction regression model using equation (1) as described above. The rate system determiner 220 considers and configures at least one of whether an ambient temperature belongs to a normal range and whether a meteorological forecast belongs to a normal range, with respect to a temperature weight, a humidity weight, and a sunshine amount weight which are used for an application of the power prediction regression model. That is, as shown in FIG. 9, the rate system determiner 220 applies a weight according to an abnormal climate with respect to a weight applied to the climate response power prediction regression model when the ambient temperature does not belong to a normal range. Meanwhile, under a condition in that ambient temperature belongs to a normal range, when a climate forecast belongs to a normal range, the rate system determiner 220 applies a weight which belongs to a meteorological administration forecast error range with respect to a weight applied to the climate response power prediction regression model. Further, when the climate forecast is out of the normal range, the rate system determiner 220 applies a weight which belongs to a meteorological administration forecast mistake with respect to a weight applied to the climate response power prediction regression model.

In addition, when Energy Storage System (ESS) information or renewable energy information has been collected as power consumption information, the rate system determiner 220 determines the electricity rate system using the power consumption information including the ESS information and the renewable energy information. The rate system determiner 220 determines an electricity rate system by connecting with renewable energy according to at least one of the number of times of charge/discharge, a speed of charge/discharge, and battery materials of the ESS to calculate a Return On Investment (ROI).

The rate system determiner 220 uses the ESS information and renewable energy information as shown in equation (8) as described above. That is, the rate system determiner 220 determines an electricity rate system for cost-minimization connecting a charge/discharge time, amount, and speed of the ESS on the basis of the climate based renewable energy regression model using an ambient temperature, a wind speed, the amount of sunshine, a power rate, a consumption power, a life cycle of the ESS, and a charge rate of the ESS as the ESS information and the renewable energy information.

The consumption pattern determiner 230 determines an optimal power consumption pattern for minimizing power consumption of the consumer using the determined electricity rate system. The consumption pattern determiner 230 determines an optimal power consumption pattern using equations (6) and (7) as described above. That is, the consumption pattern determiner 230 determines at least one of a electricity rate system optimization value, a real-time contract power optimization value, and a real-time consumption pattern optimization value.

The consumption pattern determiner 230 configures one of the electricity rate system variable, the contract power variable, and the consumption pattern variable as a variable in present time, and the remaining variables are replaced with constant values according to dominant factors in previous time to be calculated.

For example, when it is assumed that y₁ is a yearly/monthly low cost rate system optimization value, y₂ is a real-time contract power optimization value, and y₃ is a real-time low cost consumption pattern optimization value, the consumption pattern determination unit 230 defines x_{7,t}, x_{8,t}, x_{9,t} as consumption pattern variables in a t time, defines x*_{1,t-1}, x*_{2,t-1}, x*_{t,3-1} as electricity rate system constant values in a t−1 time, and defines x*_{4,t-1}, x*_{5,t-1}, x*_{6,t-1} as contract power constant values in a t−1 time to calculate a consumption pattern optimization value corresponding to y_{3,t}. Therefore, as shown in FIG. 11, low cost rate system optimization y₁=min(power rate cost)=min(f(TOU, CPP, RTP(t)), energy pattern based contract power optimization y₂=min(contract power)=min(f(HVAC(t), Lighting(t), Appliance(t)), and device control based low cost consumption pattern optimization y₃=min(low cost consumption pattern)=min(f(Occu.(t), ZoneS.P(t), RTemp(t)), which are repeatedly calculated, converge on values satisfying a low cost rate system optimization value, a contract power optimization value, and a consumption pattern optimization value.

The control information determination unit 240 determines device control information on a device providing an energy service using the determined optimal power consumption pattern. The control information determination unit 240 determines information for a control of the HVAC on the basis of a power regression model, which connects power consumption data for the past one year or during a predetermined period and climate information, and a device control scheduling based on a setpoint calculation result.

The control information determiner 240 uses equation (9) as described above in order to detect device control information. Herein, a value ΔTemp.(t) is the difference between an external temperature and an indoor temperature and the control information determiner 240 detects control information enabling air conditioning and heating according to ΔTemp.(t) to be adjusted. For example, the control information determiner 240 detects control information allowing ΔTemp.(t) to be larger than or equal to proper positive number in summer, and detects control information allowing ΔTemp.(t) to be less than or equal to a proper negative number in winter. To this end, the control information determiner 240 calculates a configuration temperature (setpoint) on the basis of an ambient temperature-based consumption power regression model for the past one year or during a predetermined period and a regression model of deducted consumption power and (indoor temperature-configuration temperature). That is, a consumption pattern based device interwork control value may be determined through a multi-regression model. The control information determiner 240 uses a machine running method such as polynomial regression, ANN, and SVR as the regression model.

The controller 250 controls general operations of the interface 200, the database 210, the rate determiner 220, the consumption pattern determiner 230, and the control information determiner 240. In addition, according to an exemplary embodiment, operations of the rate determiner 220, the consumption pattern determiner 230, and the control information determiner 240 may be executed in the controller 250. The controller 250 may be embodied by at least one processor. Similarly, the rate determiner 220, the consumption pattern determiner 230, and the control information determiner 240 may be embodied by at least one processor. Further, the interface 200 may include a transceiver which transmits and receives a signal.

As described above, according to an exemplary embodiment, a consumer customized electricity rate system is recommended on the basis of a contract power, thereby reducing a power rate. According to an exemplary embodiment, a consumer customized low cost rate system connecting past power data, climate data, and a future event is recommended, thereby reducing a cost by a power use. Further, according to an exemplary embodiment, an operation of a power consumption device is controlled (e.g., temperature control, and driving mode control) on the basis of a recommended rate system, thereby reducing a cost by a power use.

The methods according to exemplary embodiments disclosed herein and/or defined by the appended claims may be implemented in the form of hardware, software, or a combination of hardware and software. When the methods are implemented by software, a computer-readable storage medium storing at least one program (software module) may be provided. The at least one program stored in the computer-readable storage medium may be configured for execution by one or more processors in the electronic device. The one or more programs may include instructions that cause the electronic device to perform the methods according to exemplary embodiments disclosed herein or in the appended claims.

The programs (software modules or software) may be stored in non-volatile memories including a random access memory and a flash memory, a Read Only Memory (ROM), an Electrically Erasable Programmable Read Only Memory (EEPROM), a magnetic disc storage device, a Compact Disc-ROM (CD-ROM), Digital Versatile Discs (DVDs), or other type optical storage devices, or a magnetic cassette. Alternatively, any combination of some or all of the may form a memory in which the program is stored. Further, a plurality of such memories may be included in the electronic device.

In addition, the program may be stored in an attachable storage device capable of accessing the electronic device through a communication network such as the Internet, an intranet, a local area network (LAN), a wide LAN (WLAN), a storage area network (SAN), or any combination thereof. Such a storage device may access the electronic device via an external port.

What is claimed is:

1. A method for operating a server in a smart system, the method comprising:
determining an electricity rate system for an electronic device based on at least one of rate information of the electronic device and power usage information of the electronic device; and
transmitting information about the electricity rate system to a user device.

2. The method of claim 1, wherein determining the electricity rate system further comprises determining at least one of a tier-based rate system, a time of use-based rate system, a critical peak pricing-based rate system, a real-time pricing-based rate system, a promotion rate system, and a penalty rate system, based on at least one of the rate information and the power usage information,
wherein the rate information comprises at least one of a rate receipt for each time period among a plurality of time periods of the electronic device and rate transfer information, and
the power usage information comprises power consumption data for each time period among the plurality of time periods of the electronic device.

3. The method of claim 1, wherein determining the electricity rate system further comprises:
collecting climate information; and
determining the electricity rate system for the electronic device using at least one of the rate information, the power usage information, and the climate information.

4. The method of claim 1, wherein determining the electricity rate system further comprises determining an electricity rate system that minimizes power consumption costs of the electronic device based on at least one of past use information according to the rate information, the power usage information, electricity rate system information according to an area, and climate information.

5. The method of claim 4, wherein determining the electricity rate system further comprises:
predicting a future power use rate based on at least one of a past rate, a present rate, climate information according to a time zone, and energy information according to a time zone; and
determining the electricity rate system of the electronic device according to the predicted future power use rate.

6. The method of claim 5, wherein the climate information comprises at least one of temperature information, humidity information, and sunshine amount information,
wherein a weight is applied to each of the temperature information, the humidity information, and the sunshine amount information, and
wherein the weight applied to each of the temperature information, the humidity information, and the sunshine amount information is determined based on at least one of whether an ambient temperature is in a normal range of ambient temperatures and whether a climate forecast is in a normal range of climate forecasts.

7. The method of claim 1, wherein determining the electricity rate system further comprises:
collecting at least one of energy storage system information and renewable energy information; and
determining the electricity rate system for the electronic device according to at least one of the rate information and the power usage information, and according to at least one of the energy storage system information and the renewable energy information.

8. The method of claim 7, wherein determining the electricity rate system further comprises:
determining renewable energy based on at least one of an ambient temperature, a wind speed, and an amount of sunshine; and
determining the electricity rate system based on at least one of the determined renewable energy, a power rate, a prediction of the amount of power consumed for one day, a life cycle of the energy storage system, and a charging rate of the energy storage system.

9. The method of claim 1, further comprising:
determining a power consumption pattern for minimizing power consumption of the electronic device based on the determined electricity rate system;
determining device control information corresponding to the power consumption pattern; and
transmitting at least one of the determined power consumption pattern and the device control information to at least one of the user device and the electronic device,
wherein the power consumption pattern is determined based on at least one of an electricity rate system variable, a contract power variable, and a consumption pattern variable, and the power consumption pattern comprises at least one of an electricity rate system optimization value, a real-time contract power optimization value, and a real-time consumption pattern optimization value.

10. A server device of a smart system, the server device comprising:
a processor configured to determine an electricity rate system corresponding to an electronic device based on at least one of rate information according to past use of the electronic device and power usage information of the electronic device; and
a transceiver configured to transmit information about the electricity rate system to a user device.

11. The server device of claim 10, wherein the processor is further configured to determine that the electricity rate system comprises at least one of a tier-based rate system, a time of use-based rate system, a critical peak pricing-based rate system, a real-time pricing-based rate system, a promotion rate system, and a penalty rate system, based on at least one of the rate information and the power usage information,
wherein the rate information comprises at least one of a rate receipt for each time period among a plurality of time periods of the electronic device and rate transfer information, and
the power usage information comprises power consumption data for each time period among the plurality of time periods of the electronic device.

12. The server device of claim 10, wherein the processor is further configured to collect climate information and determine the electricity rate system for the electronic device according to at least one of the rate information, the power usage information, and the climate information.

13. The server device of claim 10, wherein the processor is further configured to determine the electricity rate system that minimizes power consumption costs of the electronic device on the basis of at least one of the past use information according to the rate information, the power usage information, electricity rate system information according to an area, and climate information.

14. The server device of claim 13, wherein the processor is further configured to predict a future power use rate on the basis of at least one of a past rate, a present rate, climate information according to a time zone, and energy information according to a time zone, and determine the electricity rate system of the electronic device according to the predicted future power use rate.

15. The server device of claim 14, wherein the climate information comprises at least one of temperature information, humidity information, and sunshine amount information,
wherein a weight is applied to each of the temperature information, the humidity information, and the sunshine amount information, and
wherein the weight applied to each of the temperature information, the humidity information, and the sunshine amount information is determined on the basis of at least one of whether an ambient temperature is in a normal range of ambient temperatures and whether a climate forecast is in a normal range of climate forecasts.

16. The server device of claim 10, wherein the processor is further configured to collect at least one of energy storage system information and renewable energy information, and determine the electricity rate system for the electronic device according to at least one of the rate information and the power usage information, and according to at least one of the energy storage system information and the renewable energy information.

17. The server device of claim 16, wherein the processor is further configured to determine renewable energy based on at least one of an ambient temperature, a wind speed, and the amount of sunshine, and determine the electricity rate system based on at least one of the determined renewable energy, a power rate, a prediction of the amount of consumed power for one day, a life cycle of the energy storage system, and a charging rate of the energy storage system.

18. The server device of claim 10, wherein the processor is further configured to determine a power consumption pattern for minimizing power consumption of the electronic device on the basis of the determined electricity rate system, determine device control information corresponding to the power consumption pattern, and transmit at least one of the determined power consumption pattern and the determined device control information to at least one of the user device and the electronic device.

19. The server device of claim 18, wherein the processor is further configured to determine the power consumption pattern on the basis of at least one of an electricity rate system variable, a contract power variable, and a consumption pattern variable, and wherein the power consumption pattern comprises at least one of an electricity rate system optimization value, a contract power optimization value, and a consumption pattern optimization value.

20. A method of optimizing a smart system, the method comprising:
collecting rate information of an electronic device and power usage information of the electronic device over a predetermined time period;
predicting an amount of power consumption of the electronic device on the basis of the collected rate information and the collected power usage information over a future time period; and
determining an optimal rate system by minimizing the amount of power consumption of the electronic device over the future time period based on the predicted amount of power consumption.
